(19) United States
(12) Patent Application Publication
(10) Pub. No.: US 2023/0189810 A1
(43) Pub. Date: Jun. 22, 2023

(54) AQUEOUS COMPOSITION OF DITHIOCARBAMATE FUNGICIDE

(71) Applicants: Wilhelmus Maria VAN DER KRIEKEN, Wageningen (NL); Christian STRATMANN, Wageningen (NL); Adama Makhteshim Ltd., Beer Sheva (IL)

(72) Inventors: Wilhelmus Maria Van Der Krieken, Wageningen (NL); Christian Stratmann, Wageningen (NL)

(73) Assignee: Adama Makhteshim Ltd., Beer Sheva (IL)

(21) Appl. No.: 17/926,823

(22) PCT Filed: May 28, 2021
(86) PCT No.: PCT/IB2021/054696

§ 371 Date: Nov. 21, 2022

Related U.S. Application Data
(60) Provisional application No. 63/031,139, filed on May 28, 2020.

(51) Int. Cl. A01N 47/14; A01P 3/00; A01N 25/04

(52) U.S. Cl. CPC A01N 47/14; A01P 3/00; A01N 25/04

(57) ABSTRACT

The invention relates to an aqueous composition comprising polyelectrolyte complex, dithiocarbamate fungicide, an aqueous carrier and an agriculturally acceptable additive. The invention further relates to a method for producing the aqueous composition according to the invention and to the use of said composition. The invention additionally relates to a method of protecting a plant, and to a method of preventing, reducing and/or eliminating the presence of a pathogen on a plant, by contacting said plant with a composition of the invention.

Throughout this application various publications are referenced. The disclosures of these documents in their entireties are hereby incorporated by reference into this application in order to more fully describe the state of the art to which this invention pertains.

### FIELD

The present invention relates to an aqueous concentrate composition comprising a polyelectrolyte complex and a dithiocarbamate fungicide. The invention further relates to methods for producing the composition and to methods of preventing, reducing and/or eliminating the presence of a phytopathogen on a plant or on one or more plant parts, comprising applying a composition of the invention to said plant or plant part.

### 1. INTRODUCTION

Agricultural pest control includes biological control means such as crop rotation, companion planting, breeding of pest-resistant cultivars, and the use of living organisms such as dogs to catch rodents, the use of physical traps such as sticky flypapers, garden guns, and the application of chemical control means. Chemical control is based on substances that are toxic to the pests involved, while causing little or no toxic effects to the agricultural plants. Chemical control agents or pesticides include lime and wood ash, sulphur, bitumen, nicotine, heavy metals such as copper, lead and mercury, and neem oil.

Chemical control agents can be incredibly beneficial and have contributed to increased food production over the past century. However, when a pesticide is applied it may be carried into the environment by leaching into the soil or drifting through the air. In addition, pesticide exposure to human sometimes may cause adverse health effects ranging from simple irritation of the skin and eyes to more severe effects such as affecting the nervous system. A major challenge in agriculture, therefore, is to control plant pests while reducing the amounts of chemical control agents that are applied.

Compositions of a pesticide may be used to enhance performance of the pesticide and, thereby, reduce the amount that is to be applied to be effective against the agricultural pest. A formulation may, for example, increase stickiness, increase rainfastness, and/or provide longer duration by slow release of the active ingredient.

Dithiocarbamate fungicide are fungicide which used for controlling a various of pathogen in different crops. Different compositions are known comprising dithiocarbamate fungicide especially, Mancozeb. Most dithiocarbamates such as mancozeb are hardly soluble in water. Mancozeb has a solubility at 20° C. of about 6.2 mg per liter. Present commercial formulations such as Dithane (Dow Agrosciences), and penncozeb (Elf Atochem) are formulated as water dispersible granules (WG) or wettable powders (WP), with high concentrations of mancozeb as active ingredient in the range of 70-80%.

The published international application WO 2013/133705 and WO 2013/133706 describe the use of a neutral, insoluble polyelectrolyte complex, generated by mixing solutions of a polycation and a polyanion. Said polyelectrolyte complex was found to improve the protective effect of a biocide that was adhered to the polyelectrolyte complex, in comparison with the same biocide without said polyelectrolyte complex.

It is an objective of the present invention to provide an aqueous compositions and methods that allow increase in the use and activity of a dithiocarbamate fungicide to protect a plant against phytopathogenic pests. Said composition preferably increases the activity of the dithiocarbamate fungicide.

### 2. SUMMARY OF THE INVENTION

The present invention provides an aqueous concentrate composition comprising a polyelectrolyte complex, a dithiocarbamate fungicide, an aqueous carrier and an agriculturally acceptable additive.

The invention also provides an aqueous concentrate composition wherein the concentration of the dithiocarbamate fungicide is up to 45% by weight based on the total weight of the composition.

The present invention provides a suspension concentrate comprising a polyelectrolyte complex, dithiocarbamate fungicide and an aqueous carrier.

The invention also provides a suspension concentrate comprising a polyelectrolyte complex, mancozeb, and an aqueous carrier.

The present invention also provides a dithiocarbamate fungicide delivery system comprising a polyelectrolyte complex, dithiocarbamate fungicide, an aqueous carrier and an agriculturally acceptable additive.

In an aspect, the invention provides a method of protecting a plant, or a part of a plant, against a pathogen, comprising contacting said plant, or part of said plant, with a composition according to the invention.

In an aspect, the invention provides a method of preventing, reducing and/or eliminating the presence of a pathogen on a plant, or a part of a plant, comprising contacting said plant, or part of said plant, with a composition according to the invention.

In an aspect, the invention provides a method of controlling diseases caused by phytopathogenic fungi in plants or on propagation material thereof which comprises contacting the plants, or propagation material thereof, with a composition according to the invention.

### 3. DETAILED DESCRIPTION

### 3.1 Definitions

Unless defined otherwise, all technical and scientific terms used herein have the meaning commonly understood by persons of ordinary skill in the art to which this subject matter pertains.

The term “a” or “an”, as used herein, includes the singular and the plural, unless specifically stated otherwise. Therefore, the terms “a,” “an,” or “at least one” can be used interchangeably in this application.

As used herein, the term “about” when used in connection with a numerical value includes ±10% from the indicated value. In addition, all ranges directed to the same component or property herein are inclusive of the endpoints, are independently combinable, and include all intermediate points and ranges. It is understood that where a parameter range is provided, all integers within that range, and tenths thereof, are also provided by the invention. For example, “30-45%” includes 30%, 30.1%, 30.2%, etc. up to 45%.

The term “polyelectrolyte”, as is used herein, refers to a molecule consisting of a plurality of functional, charged groups that are linked to a polymer backbone. In the context of this application, the term “polycation” is interchangeable with the term “positively charged polyelectrolyte”, while the term “polyanion” is interchangeable with the term “negatively charged polyelectrolyte”. The terms polycation and polyanion refer to positively charged and negatively charged polymer molecules, respectively, under neutral or acidic conditions, i.e. at pH 3-8. Moreover, the term “polycation” refer to a cationic polymer and the term “polyanion” refer to a anionic polymer.

The term “polyelectrolyte complex”, as is used herein, refers to a structure that is formed by interaction of at least one polycation with at least one polyanion. Polyelectrolyte complexes are described, for example, in WO 2013/133705 and WO 2013/133706, the contents of each of which are hereby incorporated by reference. An example of polyelectrolyte complex may be a “polyelectrolyte matrix” (“PEM”).

The term “polyelectrolyte matrix”, as is used herein, refers to a network that is formed by interaction of at least one polycation with at least one polyanion that result in a matrix like physical structure.

The term “macromolecular complex”, as is used herein, refers to structure that is formed by non-covalent interaction of a dithiocarbamate fungicide with a polyelectrolyte, such as at least one polycation, at least one polyanion, or at least one polyelectrolyte complex. In such macromolecular complex, the non-covalent interactions are preferably electrostatic interactions. The macromolecular complex thus avoids the use of covalent cross-linkers.

The term “electrostatic interaction” as is used herein, refers to electric force between any two charged molecules and/or dipole molecules. The term “electrostatic interactions” includes ionic interactions, hydrogen bonds, and van der Waals forces such as dipole-dipole interactions.

The term “ionizable”, as is used herein, refers to a polymer (polyelectrolyte) which comprises a functional group(s) that can be ionized or protonated in an aqueous solution. Said molecules are capable of dissociating into the corresponding cation and anion, similar to salts such as copper sulfate.

The term “lignin compound”, as is used herein, refers to a chemical compound that is derived from naturally occurring lignin or lignen by a process that includes sulphonation. The resulting sulfonic acids are strong acids and lignin compounds are therefore negatively charged at pH values below 7.

As used herein, the term “chitosan” refers to a linear polysaccharide composed of randomly distributed β-(1-4)-linked D-glucosamine (deacetylated unit) and N-acetyl-D-glucosamine (acetylated unit). Chitosan is produced by deacetylation of chitin. The term “chitosan” includes chitosan, chitosan derivatives and mixtures of chitosan and chitosan derivatives.

The term “crop”, as is used herein, include cereals such as wheat, barley, rye, oats, sorghum and millet, rice, cassava and maize, and crops that produce, for example, peanut, sugar beet, cotton, soya, oilseed rape, potato, tomato, peach and vegetables.

The term “part of a plant”, as is used herein, indicates a part of a plant including, but not limited to, pollen, ovule, leaf, root, flower, fruit, stem, bulb, corn, branch and seed.

The term “bioactive ingredient”, as is used herein with connection to an additional bioactive ingredient, refers to a chemical substance capable of controlling pests and/or killing living organisms. Bioactive ingredients are commonly used in medicine, agriculture, forestry, and in industry where they prevent the fouling of, for example, water, agricultural products including seed, and oil pipelines. A bioactive ingredient can be a pesticide, including a fungicide, herbicide, insecticide, algicide, molluscicide, miticide and rodenticide; and/or an antimicrobial such as a germicide, antibiotic, antibacterial, antiviral, antifungal, antiprotozoal and/or antiparasitic compound.

As used herein, the term “pest” includes, but is not limited to, insect, nematode, weed, fungi, algae, mite, tick, and animal. Said pest preferably is a phytopathogenic fungi, an unwanted insect, and/or a weed.

As used herein, the term “weed” refers to any unwanted vegetation.

As is used herein, the term “pesticide” includes, but is not limited to, a herbicide, insecticide, fungicide, nematocide, mollusks repellent and a control agent.

The terms “controlling a pest” and “pest control”, as used herein, refers to preventive, persistence, curative and/or knock down treatment of a pest.

The term “polyene fungicide”, as used herein, refers to a polyene macrolide antifungal that possess antifungal activity such as natamycin, lucensomycin, filipin, nystatin or amphotericin B, most preferred natamycin. Derivatives of a polyene fungicide, such as derivatives of natamycin, are also included. A preferred derivative is a salt or a solvate of a polyene fungicide and/or a modified form of a polyene fungicide such as e.g. different shaped crystal forms such as the needle-shaped crystal of natamycin described in U.S. Pat. No. 7,727,966.

The term “suspension concentrate”, as used herein, refers to a suspension of solid particles in a liquid intended for dilution with water prior to use. In some embodiments, suspension concentrate refers to an aqueous suspension concentrate. Suspension concentrate is a type of composition.

The term “stable”, as used herein in connection with physical stability, e.g. physically stable, and when used in connection with a composition, means that the composition meets the physical stability standards set forth by the Collaborative International Pesticides Analytical Council (CIPAC). The CIPAC is an international, organization that promote international agreements on methods for the analysis of pesticides and physico-chemical test methods for compositions. Methods adopted by the CIPAC are published in the CIPAC Handbooks, available online at https://www.cipac.org/index.php/methods-publications, the entire content of each method is hereby incorporated by reference into the subject application. In some embodiments, stable refers to a composition with decrease in agglomeration rate and/or phase separation.

The term “tank mix”, as used herein, refers to at least two compositions that are mixed in the spray tank prior to the application or at the time of spray application.

The term “water dispersible granules”, as used herein, refers to a formulation in granule form which is dispersible in water forming a dispersion such as a suspension or solution.

The term “wettable powder”, as used herein, refers to a powder formulation intended to be mixed with water or another liquid prior to use.

The term “water slurriable powder”, as used herein, refers to a powder formulation that is made into a slurry in water prior to use.

### 3.2 Aqueous Concentrate Composition

Formulating an aqueous composition comprising mancozeb, especially in high concentration of 30% and above by weight, is a challenge. The challenge is due to the fact that mancozeb, especially in the presence of a polyelectrolyte, becomes viscous and during storage agglomeration occurs. Agglomeration of mancozeb is a well-known phenomenon in aqueous compositions.

Composition comprising polyelectrolyte matrix (PEM) and mancozeb may have issues of physical stability, such as viscosity increase, particle size, aggregation, and/or phase separation, due to use of dispersant(s). There is no published data regarding the storage stability of PEM formulations. There is also no published data on how non-ionic and/or ionic additives (such as surfactants) affect the PEM formulation during manufacturing and storage.

The inventors have improved the preparation process, upscaling, manufacturing and storage of compositions comprising a polyelectrolyte complex and a dithiocarbamate fungicide by finding the combinations of wetting agent(s) and dispersant(s) that provide good viscosity and physical stability without problems of aggregates or phase separation during manufacturing or long-term storage.

The present invention provides a suspension concentrate comprising a polyelectrolyte complex, a dithiocarbamate fungicide, and an aqueous carrier. In some embodiments, the dithiocarbamate fungicide is a dimethyldithiocarbamate such as ferbam (iron(III) dimethyldithiocarbamate), ziram (zinc dimethyldithiocarbamate), thiram (dimethylcarbamothioylsulfanyl-N,N-dimethyldithiocarbamate), propineb (zinc propylenebis(dithiocarbamate) and an ethylenebisdithiocarbamate.

A preferred dithiocarbamate is or comprises an ethylene bisdithiocarbamate (EBDC) such as sodium ethylenebisdithiocarbamate (nabam), zinc ammoniate ethylenebis(dithiocarbamate)-poly(ethylenethiuram disulfide) (metiram). A more preferred EBDC is in the form of a complex with manganese (maneb), zinc (zineb) or, most preferably, a combination of manganese and zinc (mancozeb; zinc; manganese(2+); N-[2-(sulfidocarbothioylamino)ethyl]carbamodithioate or [[2-[(dithiocarboxy)amino] ethyl] carbamodithioato(2-)-κS,κS′] manganese mixture with [[2-[(dithiocarboxy) amino]ethyl] carbamodithioato (2-)-κS,κS′]zinc). A preferred dithiocarbamate in a composition of the invention is mancozeb.

In some embodiments, the dithiocarbamate fungicide is mancozeb.

The concentration of the polyelectrolyte complex in a composition according to the invention is preferably 0.01-10% by weight based on the total weight of the stable composition. The concentration of the polyelectrolyte complex in the composition is 1-5% by weight based on the total weight of the stable composition. The concentration of the polyelectrolyte complex in the composition is 2-4% by weight based on the total weight of the stable composition. The concentration of the polyelectrolyte complex in the composition is about 3% by weight based on the total weight of the stable composition. The concentration of the polyelectrolyte complex in the composition is 2.8% by weight based on the total weight of the stable composition. The concentration of the polyelectrolyte complex in the composition is 3.2% by weight based on the total weight of the stable composition. The concentration of the polyelectrolyte complex in the composition is 3.3% by weight based on the total weight of the stable composition.

The concentration of the polyelectrolyte complex in a composition according to the invention is preferably 0.01-10% by weight based on the total weight of the composition. The concentration of the polyelectrolyte complex in the composition is 1-5% by weight based on the total weight of the composition. The concentration of the polyelectrolyte complex in the composition is 2-4% by weight based on the total weight of the composition. The concentration of the polyelectrolyte complex in the composition is about 3% by weight based on the total weight of the composition. The concentration of the polyelectrolyte complex in the composition is 2.8% by weight based on the total weight of the composition. The concentration of the polyelectrolyte complex in the composition is 3.2% by weight based on the total weight of the composition. The concentration of the polyelectrolyte complex in the composition is 3.3% by weight based on the total weight of the composition.

In some embodiments, the concentration of the polyanion in the composition is less than 3% by weight based on the total weight of the composition. In some embodiments, the concentration of the polyanion in the composition is less than 2.5% by weight based on the total weight of the composition. In some embodiments, the concentration of the polyanion in the composition is less than 2% by weight based on the total weight of the composition. In some embodiments, the concentration of the polyanion in the composition is less than 1.5% by weight based on the total weight of the composition. In some embodiments, the concentration of the polyanion in the composition is less than 1% by weight based on the total weight of the composition. In some embodiments, the concentration of the polyanion in the composition is less than 0.5% by weight based on the total weight of the composition.

In some embodiments, the composition is free of polyanion. In some embodiments, the concentration of the polyanion in the composition is 0.01-5% by weight based on the total weight of the composition. In some embodiments, the concentration of the polyanion in the composition is 1-3% by weight based on the total weight of the composition. In some embodiments, the concentration of the polyanion in the composition is 2-2.5% by weight based on the total weight of the composition. In some embodiments, the concentration of the polyanion in the composition is about 2% by weight based on the total weight of the composition.

In some embodiments, the concentration of the polycation in the composition is 0.01-10% by weight based on the total weight of the composition. In some embodiments, the concentration of the polycation in the composition is 0.1-5% by weight based on the total weight of the composition. In some embodiments, the concentration of the polycation in the composition is 0.1-1.5% by weight based on the total weight of the composition. In some embodiments, the concentration of the polycation in the composition is about 0.5% by weight based on the total weight of the composition. In some embodiments, the concentration of the polycation in the composition is about 0.5% by weight based on the total weight of the composition. In some embodiments, the concentration of the polycation in the composition is about 1% by weight based on the total weight of the composition.

In some embodiments, the concentration of the polycation in the composition is 0.01-5% by weight based on the total weight of the composition. In some embodiments, the concentration of the polycation in the composition is 0.01-2% by weight based on the total weight of the composition. In some embodiments, the concentration of the polycation in the composition is 0.3-1.2% by weight based on the total weight of the composition. In some embodiments, the concentration of the polycation in the composition is about 0.5% by weight based on the total weight of the composition. In some embodiments, the concentration of the polycation in the composition is about 1% by weight based on the total weight of the composition.

In some embodiments, the weight ratio between the polyelectrolyte complex and the mancozeb is between 1:5 and 1:15. In some embodiments, the weight ratio between the polyelectrolyte complex and the mancozeb is between 1:9 and 1:12. In some embodiments, the weight ratio between the polyelectrolyte complex and the mancozeb is between 1:9 and 1:11. In some embodiments, the weight ratio between the polyelectrolyte complex and the mancozeb is between 1:10 and 1:11. In some embodiments, the weight ratio between the polyelectrolyte complex and the mancozeb is about 1:11. In some embodiments, the weight ratio between the polyelectrolyte complex and the mancozeb is about 1:10. In some embodiments, the weight ratio between the polyelectrolyte complex and the mancozeb is about 1:9.

The concentration of the dithiocarbamate fungicide in a composition according to the invention is preferably between 10 and 1000 g/L, more preferred between 100 and 500 g/L such as between 300 and 400 g/L. In some embodiments, the concentration of the dithiocarbamate fungicide in the composition is between 350 and 450 g/L. In some embodiments, the concentration of the dithiocarbamate fungicide in the composition is about 390-420 g/L. In some embodiments, the concentration of the dithiocarbamate fungicide in the composition is about 360 g/L. In some embodiments, the concentration of the dithiocarbamate fungicide in the composition is about 390 g/L. In some embodiments, the concentration of the dithiocarbamate fungicide in the composition is about 420 g/L.

The concentration of the dithiocarbamate fungicide in a composition according to the invention preferably is 10-80% by weight based on the total weight of the composition, more preferred 10-50% by weight based on the total weight of the composition, such as 25-40% by weight based on the total weight of the stable composition.

In some embodiments, the concentration of the dithiocarbamate fungicide in the composition is up to 45% by weight based on the total weight of the composition.

In some embodiments, the concentration of the dithiocarbamate fungicide in the composition is 30-45% by weight based on the total weight of the composition.

In some embodiments, the concentration of the dithiocarbamate fungicide in the composition is 30-40% by weight based on the total weight of the composition.

In some embodiments, the concentration of the dithiocarbamate fungicide in the composition is 28-37% by weight based on the total weight of the composition. In some embodiments, the concentration of the dithiocarbamate fungicide in the composition is 29-35% by weight based on the total weight of the composition. In some embodiments, the concentration of the dithiocarbamate fungicide in the composition is 30-35% by weight based on the total weight of the composition. In some embodiments, the concentration of the dithiocarbamate fungicide in the composition is about 30% by weight based on the total weight of the composition. In some embodiments, the concentration of the dithiocarbamate fungicide in the composition is about 33% by weight based on the total weight of the composition. In some embodiments, the concentration of the dithiocarbamate fungicide in the composition is about 35% by weight based on the total weight of the composition.

In some embodiments, the composition further comprises an agriculturally acceptable inert additive.

In some embodiments, the agriculturally acceptable inert additive may include but is not limited to, antifoams, solvents, co-solvent, light stabilizers, UV absorbers, radical scavengers and antioxidants, adhesives, neutralizers, thickeners, binders, sequestrates, biocides, buffers preservatives, and anti-freeze agents. The addition of an additive affects the chemically and physically stability of the compositions.

In some embodiments, the agriculturally acceptable inert additive is the thickener and biocide (preservative) anti foaming agent. In some embodiments, the amount of the thickener and biocide up to 1% by weight based on the total weight of the composition. In some embodiments, the thickener is Xanthan gum.

In some embodiments, the composition further comprises an agriculturally acceptable additive, wherein the said additive improves the stability of the composition. In some embodiments, the agriculturally acceptable additive is a combination of at least one dispersant and one wetting agent. In some embodiments, the weight ratio between the dispersant and the wetting agent in the composition is between 10:1 to 1:10. In some embodiments, the weight ratio between the dispersant and the wetting agent in the composition is between 10:1 to 1:2. In some embodiments, the weight ratio between the dispersant and the wetting agent in the composition is between 5:1 to 1:5. In some embodiments, the weight ratio between the dispersant and the wetting agent in the composition is between 5:1 to 1:2. In some embodiments, the weight ratio between the dispersant and the wetting agent in the composition is between 2:1 to 1:2. In some embodiments, the weight ratio between the dispersant and the wetting agent in the composition is between 2:1 to 1:1. In some embodiments, the weight ratio between the dispersant and the wetting agent in the composition is between 1:1 to 1:2. In some embodiments, the weight ratio between the dispersant and the wetting agent in the composition is 1:1. In some embodiments, the weight ratio between the dispersant and the wetting agent in the composition is 1:2. In some embodiments, the composition is a suspension concentrate and the weight ratio between the dispersant and the wetting agent in the composition is 1:2.

In some embodiments, the additive is selected from buffers, acidifiers, defoaming agents, thickeners, drift retardants, surfactant, pigments, wetting agents, safeners, and preservatives. Said additives include, but are not limited to, surfactants, pigments, wetting agents, as well as safeners, or such preservatives as bacteriostats or bactericides.

In some embodiments, the agriculturally acceptable additive may include but is not limited to surfactants, wetting agent, antifoams, solvents, co-solvent, light stabilizers, UV absorbers, radical scavengers and antioxidants, adhesives, neutralizers, thickeners, binders, sequestrates, biocides, buffers preservatives, and anti-freeze agents.

In some embodiments, the agriculturally acceptable additive is an agriculturally acceptable carrier. In some embodiments, the composition comprises at least one agriculturally acceptable carrier.

Said agriculturally acceptable carrier preferably includes a stabilizer, a wetting agent, a dispersant, an antifreezing agent, an antifoaming agent and/or a thickening agent. The addition of small amounts of one or more agriculturally acceptable carriers may affect parameters such as stability, efficacy and/or rainfastness of a composition according to the invention. The addition of small amounts of one or more agriculturally acceptable carriers preferably increases stability, efficacy and/or rainfastness of a composition according to the invention.

In some embodiments, the agriculturally acceptable carrier is water.

In some embodiments, the composition comprises 40-80% by weight of water. In some embodiments, the composition comprises 50-70% by weight of water. In some embodiments, the composition comprises 50-55% by weight of water. In some embodiments, the composition comprises 40-80% by weight of water. In some embodiments, the composition comprises 45-55% by weight of water. In some embodiments, the composition comprises about 47% by weight of water. In some embodiments, the composition comprises about 510% by weight of water. In some embodiments, the composition comprises about 53% by weight of water. In some embodiments, the composition comprises about 62% by weight of water.

In some embodiments, an agriculturally acceptable additive is a dispersant.

In some embodiments, the agriculturally acceptable additive is a wetting agent.

In some embodiments, the agriculturally acceptable additive is a surfactant. In some embodiments, the agriculturally acceptable additive is a mixture of two or more surfactants.

In some embodiments, the surfactant(s) is a dispersant and/or a wetting agent.

In some embodiments, the surfactants are a dispersant and a wetting agent.

A dispersant, when present, is preferably selected from Morwet® D425 (sold by Nouryon), lignin sulphonate, an alkylpolysaccharide, an styrene acrylic polymer, an acrylic co-polymer, and ethoxylated tristyrenephenol phosphate, for example polyethoxylated fosforic acid. A composition of the invention may also comprise two or more different dispersants.

A dispersant is preferably present in an amount of between 0 to up to 10% (w/v), more preferred between 0.01 to up to 5% (w/v), more preferred between 0.02 to up to 1% (w/v), more preferred about 0.05% (w/v).

In some embodiments, the composition comprises a dispersant of 2-10% by weight based on the total weight of the composition.

In some embodiments, the concentration of the dispersant in the composition is 0-15% by weight based on the total weight of the composition. In some embodiments, the concentration of the dispersant in the composition is 0-12% by weight based on the total weight of the composition.

In some embodiments, the concentration of the dispersant in the composition is 1-12% by weight based on the total weight of the composition. In some embodiments, the concentration of the dispersant in the composition is 0-10% by weight based on the total weight of the composition. In some embodiments, the concentration of the dispersant in the composition is 1-5% by weight based on the total weight of the composition. In some embodiments, the concentration of the dispersant in the composition is 5-10% by weight based on the total weight of the composition. In some embodiments, the concentration of the dispersant is about 5% by weight based on the total weight of the composition. In some embodiments, the concentration of the dispersant is about 6% by weight based on the total weight of the composition. In some embodiments, the concentration of the dispersant is about 7% by weight based on the total weight of the composition. In some embodiments, the concentration of the dispersant is about 8% by weight based on the total weight of the composition. In some embodiments, the concentration of the dispersant is about 9% by weight based on the total weight of the composition. In some embodiments, the concentration of the dispersant is about 10% by weight based on the total weight of the composition.

In some embodiments, the composition comprises 1-5% by weight of dispersant(s). In some embodiments, the composition comprises 1.5-3.5% by weight of dispersant(s). In some embodiments, the composition comprises 2-3% by weight of dispersant(s). In some embodiments, the composition comprises about 2% by weight of dispersant(s). In some embodiments, the composition comprises about 3% by weight of dispersant(s).

In some embodiments, the dispersant is selected from a group consisting of a modified acrylic polymer, non-modified acrylic acid, sulfonate polymer and any combination thereof.

In some embodiments, the modified acrylic polymer is modified styrene acrylic acid, polymethyl methacrylate-polyethylene glycol graft copolymer or any combination thereof. In some embodiments, modified acrylic polymer is modified styrene acrylic polymer. In some embodiments, the modified styrene acrylic polymer is Atlox Metasperse™ 500 L (sold by Croda). In some embodiments, the modified acrylic polymer is polymethyl methacrylate-polyethylene glycol graft copolymer. In some embodiments, the polymethyl methacrylate-polyethylene glycol graft copolymer is Atlox™ 4913 (sold by Croda).

In some embodiments, the composition comprises 1-5% by weight of modified styrene acrylic polymer. In some embodiments, the composition comprises 1.5-3.5% by weight of modified styrene acrylic polymer. In some embodiments, the composition comprises 2-3% by weight of modified styrene acrylic polymer. In some embodiments, the composition comprises about 2% by weight of modified styrene acrylic polymer. In some embodiments, the composition comprises about 3% by weight of modified styrene acrylic polymer.

In some embodiments, the sulfonate polymer is a lignin. In some embodiments, the lignin is sodium lignosulfonate and/or calcium lignosulfonate and combination thereof. In some embodiments, the sulfonate polymer is sodium salt of naphthalene sulfonate condensate. In some embodiments, the sodium salt of naphthalene sulfonate condensate is Morwet D-425.

In some embodiments, the dispersant is lignosulfonate, a modified acrylic polymer or a combination thereof.

In some embodiments, the dispersant is lignosulfonate.

In some embodiments, the concentration of the lignosulfonate in the composition is 0-12% by weight based on the total weight of the composition. In some embodiments, the concentration of the lignosulfonate in the composition is 1-12% by weight based on the total weight of the composition. In some embodiments, the concentration of the lignosulfonate in the composition is 0-10% by weight based on the total weight of the composition. In some embodiments, the concentration of the lignosulfonate in the composition is 1-5% by weight based on the total weight of the composition. In some embodiments, the concentration of the lignosulfonate in the composition is 5-10% by weight based on the total weight of the composition. In some embodiments, the concentration of the lignosulfonate is about 5% by weight based on the total weight of the composition. In some embodiments, the concentration of the lignosulfonate is about 6% by weight based on the total weight of the composition. In some embodiments, the concentration of the lignosulfonate is about 7% by weight based on the total weight of the composition. In some embodiments, the concentration of the lignosulfonate is about 8% by weight based on the total weight of the composition. In some embodiments, the concentration of the lignosulfonate is about 9% by weight based on the total weight of the composition. In some embodiments, the concentration of the lignosulfonate is about 10% by weight based on the total weight of the composition.

In some embodiments, the composition comprises a dispersant and a wetting agent. In some embodiments, the dispersant is a polymer. In some embodiments, the wetting agent is a polymer. In some embodiments, the dispersant is anionic. In some embodiments, the wetting agent is nonionic. In some embodiments, the composition comprises a nonionic wetting agent and an anionic dispersant. In some embodiments, the dispersant is anionic polymer. In some embodiments, the wetting agent is nonionic polymer. In some embodiments, the composition comprises a nonionic polymer wetting agent and an anionic polymer dispersant. In some embodiments, the composition comprises a modified styrene acrylic polymer as the dispersant and a polyalkylene oxide block copolymer as the wetting agent. In some embodiments, the composition comprises Atlox Metasperse™ 500 L (sold by Croda) and Atlas™ G5002 L (sold by Croda).

In some embodiments, the composition comprises one or more physical stabilizers such as buffers, acidifiers, defoaming agents, thickeners and drift retardants.

In some embodiments, the composition comprises at least one stabilizer. In some embodiments, the agriculturally acceptable additive is a stabilizer.

In some embodiments, the concentration of the stabilizer in the composition is 0.1-3% by weight based on the total weight of the composition.

A stabilizer, when present, is preferably selected from carboxylic acids such as citric acid, acetic acid, lactic acid, and/or dodecylbenzensulfonic acid, orthophosphoric acid dodecylbenzensulfonic acid and suitable salts thereof. A composition of the invention may also comprise two or more different stabilizers. A stabilizer is preferably present in an amount of between 0 to up to 10% (w/v), more preferred between 0.01 to up to 5% (w/v), more preferred between 0.02 to up to 1% (w/v), more preferred about 0.05% (w/v).

In some embodiments, the stabilizer is an acid.

Acids may include but are not limited, acetic acid, lactic acid, or citric acid.

In some embodiments, the acid is selected from group consisting of acetic acid, lactic acid, citric acid, and combination thereof. In some embodiments, the acid is acetic acid.

Acids are used to obtain dissolution of some polycation. For example, chitosan is an aminoglycan consisting of beta-(1right4)-linked D-glucosamine residues. In acidic environment, global protonation of the 2-amino groups creates cationic chitosan.

In some embodiments, an acid is used to solubilize the polycation.

In some embodiments, the acid is a C₁-C₆ carboxylic acid.

In some embodiments, the acid has a pKa lower than 5.

In some embodiments, the concentration of the acid in the composition is 0-5% by weight based on the total weight of the composition. In some embodiments, the concentration of the acid in the composition is 0.01-5% by weight based on the total weight of the composition. In some embodiments, the concentration of the acid in the composition is 1-3% by weight based on the total weight of the composition. In some embodiments, the concentration of the acid in the composition is 1.5-2% by weight based on the total weight of the composition.

In some embodiments, the composition comprises at least one anti-foam agent. In some embodiments, the agriculturally acceptable additive is an anti-foam agent.

An anti-foam agent, when present, is preferably selected from polymethylsiloxane, polydimethylsiloxane, simethicone octanol, and silicone oils. A composition of the invention may also comprise two or more different anti-foam agents. An anti-foam agent is preferably present in an amount of between 0 to up to 10% (w/v), more preferred between 0.05 to up to 5% (w/v), more preferred between 0.1 to up to 1% (w/v), more preferred about 0.05% (w/v).

In some embodiments, the anti-foam agent is silicone-based. In some embodiments, the anti-foam agent is based on polydimethylsiloxane oil. In some embodiments, the anti-foam agent is Silcolapse® 426R (manufactured and sold by Elkem Silicones). In some embodiments, the anti-foam agent is Rhodorsil® 426R.

In some embodiments, the concentration of the anti-foam forming agent is 0.01-5% by weight based on the total weight of the composition. In some embodiments, the concentration of the anti-foam forming agent is 0.1-1% by weight based on the total weight of the composition. In some embodiments, the concentration of the anti-foam forming agent is 0.2-0.7% by weight based on the total weight of the composition. In some embodiments, the concentration of the anti-foam forming agent is about 0.4% by weight based on the total weight of the composition. In some embodiments, the concentration of the anti-foam forming agent is about 0.5% by weight based on the total weight of the composition.

In some embodiments, the composition comprises at least one antifreezing agent. In some embodiments, the agriculturally acceptable additive is an antifreezing agent.

An antifreezing agent, when present, is preferably selected from glycerine, ethylene glycol, hexyleneglycol and propylene glycol. A composition of the invention may also comprise two or more different antifreezing agents. An antifreezing agent is preferably present in an amount of between 0 to up to 10% (w/v), more preferred between 0.01 to up to 5% (w/v), more preferred between 0.02 to up to 1% (w/v), more preferred about 0.05% (w/v).

In some embodiments, the antifreezing agent is propylene glycol.

In some embodiments, the concentration of the antifreezing agent in the composition is 1-10% by weight based on the total weight of the composition. In some embodiments, the concentration of the antifreezing agent in the composition is 1-5% by weight based on the total weight of the composition. In some embodiments, the concentration of the antifreezing agent in the composition is 4-4.5% by weight based on the total weight of the composition. In some embodiments, the concentration of the antifreezing agent in the composition is about 4% by weight based on the total weight of the composition. In some embodiments, the concentration of the antifreezing agent in the composition is about 5% by weight based on the total weight of the composition.

In some embodiments, the composition comprises at least one surfactant. In some embodiments, the agriculturally acceptable additive is a surfactant.

Surfactants may include but are not limited to ionic or non-ionic surface-active agents. Examples of surfactants are alkyl-end-capped ethoxylate glycol, alkyl-end-capped alkyl block alkoxylate glycol, dialkyl sulfosuccinate, phosphated esters, alkyl sulfonates, alkyl aryl sulfonates, tristyrylphenol alkoxylates, natural or synthetic fatty acid alkoxylates, natural or synthetic fatty alcohols alkoxylates, alkoxylated alcohols (such as n-butyl alcohol poly glycol ether), block copolymers (such as ethylene oxide-propylene oxide block copolymers and ethylene oxide-butylene oxide block copolymers) or combinations thereof.

Examples of surfactants include but is not limited to dispersants, emulsifiers, wetting agents.

In some embodiments, the surfactant is a non-ionic surfactant. In some embodiments, the surfactant is an anionic surfactant. In some embodiments, the surfactant is a combination of a non-ionic surfactant and an anionic surfactant. In some embodiments, the surfactant is polymeric.

In some embodiments, the concentration of the surfactant in the composition is 2%-10% by weight based on the weight of the composition. In some embodiments, the concentration of the surfactant in the composition is 2-5% w/w by weight based on the total weight of the total composition. In some embodiments, the concentration of the surfactant in the composition is about 4% by weight based on the total weight of the composition. In some embodiments, the concentration of the surfactant in the composition is about 5% by weight based on the total weight of the composition. In some embodiments, the concentration of the surfactant in the composition is about 6% by weight based on the total weight of the composition.

In some embodiments, the concentration of the surfactant in the composition is 0-0.5% by weight based on the total weight of the composition. In some embodiments, the concentration of the surfactant in the composition is 0.001-0.5% by weight based on the total weight of the composition. In some embodiments, the concentration of the surfactant in the composition is 0.01-1% by weight based on the total weight of the composition. In some embodiments, the concentration of the surfactant in the composition is about 0.10% by weight based on the total weight of the composition.

In some embodiments, the surfactant is a non-ionic hydrocarbon.

In some embodiments, the concentration of the non-ionic hydrocarbon in the composition is 0.001-0.1% by weight based on the total weight of the composition.

In some embodiments, the surfactant is not castor oil, ethoxylated (PEG-26 Castor Oil). In some embodiments, the surfactant is not tristyryphenol ethoxylate sulfate. In some embodiments, the surfactant is not tristyrylphenyl ether phosphate (Soprophor® FL sold by Solvay). In some embodiments, the surfactant is not tristyrylphenyl phosphate.

In some embodiments, wherein the composition comprises 3.3% by weight of butyl block copolymer (Atlas™ G5002L sold by Croda) and 2.5% by weight of tristyrylphenyl ether phosphate (Soprophor® FL sold by Solvay), the amount of mancozeb in the composition is not 37.5% by weight based on the total weight of the composition.

In some embodiments, wherein the composition comprises 3.3% by weight of polymethyl methacrylate-polyethylene glycol graft copolymer (Atlox™ 4913 sold by Croda) and 2.5% by weight of tristyrylphenyl ether phosphate (Soprophor® FL sold by Solvay), the amount of mancozeb in the composition is not 37.5% by weight based on the total weight of the composition.

In some embodiments, the surfactants are a wetting agent and a dispersant. In some embodiments, the concentration of the surfactants in the composition is about 6% by weight based on the total weight of the composition, wherein about 3% by weight is wetting agent and about 3% by weight is dispersant. In some embodiments, the surfactants are a wetting agent and a dispersant.

In some embodiments, the concentration of the surfactants in the composition is about 4% by weight based on the total weight of the composition, wherein about 2% by weight is wetting agent and about 2% by weight is dispersant. Preferred wetting agents and dispersants are described herein.

In some embodiments, wherein the composition comprises at least one wetting agent. In some embodiments, the agriculturally acceptable additive is a wetting agent.

A wetting agent, when present, is preferably selected from di-octylsuccinate, polyoxyethylene/polypropylene and tri-stearyl sulphonate/phosphate. A composition of the invention may also comprise two or more different wetting agents. A wetting agent is preferably present in an amount of between 0 to up to 10% (w/v), more preferred between 0.01 to up to 5% (w/v), more preferred between 0.02 to up to 1% (w/v), more preferred about 0.05% (w/v).

In some embodiments, the wetting agent is polyalkylene oxide block copolymer. In some embodiments, the wetting agent is butyl block copolymer. In some embodiments, the butyl block copolymer is Atlas™ G5002L (sold by Croda).

In some embodiments, the concentration of the wetting agent in the composition is 1-10% by weight based on the total weight of the composition. In some embodiments, the concentration of the wetting agent in the composition is 0-5% by weight based on the total weight of the composition. In some embodiments, the concentration of the wetting agent in the composition is 1-5% by weight based on the total weight of the composition. In some embodiments, the concentration of the wetting agent in the composition is 1.5-3.5% by weight based on the total weight of the composition. In some embodiments, the concentration of the wetting agent in the composition is 2-4% by weight based on the total weight of the composition. In some embodiments, the concentration of the wetting agent in the composition is 2-4.5% by weight based on the total weight of the composition. In some embodiments, the concentration of the wetting agent in the composition is 2-5% by weight based on the total weight of the composition. In some embodiments, the concentration of the wetting agent in the composition is 1-3% by weight based on the total weight of the composition. In some embodiments, the concentration of the wetting agent in the composition is about 2% by weight based on the total weight of the composition. In some embodiments, the concentration of the wetting agent in the composition is about 3% by weight based on the total weight of the composition.

In some embodiments, the concentration of the polyalkylene oxide block copolymer in the composition is 1-3% by weight based on the total weight of the composition. In some embodiments, the concentration of the polyalkylene oxide block copolymer in the composition is 1.5-3.5% by weight based on the total weight of the composition. In some embodiments, the concentration of the polyalkylene oxide block copolymer in the composition is about 2% by weight based on the total weight of the composition. In some embodiments, the concentration of the polyalkylene oxide block copolymer in the composition is about 3% by weight based on the total weight of the composition.

In some embodiments, the composition comprises at least one rheology modifier. In some embodiments, the agriculturally acceptable additive is a rheology modifier.

In some embodiments, the concentration of the rheology modifier in the composition is 1-10% by weight based on the total weight of the composition.

In some embodiments, the rheology modifier is a thickener. In some embodiments, the composition comprises at least one thickener.

A thickening agent, when present, is preferably selected from agar, alginic acid, alginate, carrageenan, gellan gum, xanthan gum, succinoglycan gum, guar gum, acetylated distarch adipate, acetylated oxidised starch, arabinogalactan, ethyl cellulose, methyl cellulose, locust bean gum, starch sodium octenylsuccinate, and triethyl citrate. A composition of the invention may also comprise two or more different thickening agents. A thickening agent is preferably present in an amount of between 0 to up to 10% (w/v), more preferred between 0.01 to up to 5% (w/v), more preferred between 0.02 to up to 1% (w/v), more preferred about 0.05% (w/v).

In some embodiments, the thickener is xanthan gum.

In some embodiments, the rheology modifier is Rhodopol® 23 (sold by Solvay). In some embodiments, the rheology modifier is xanthan gum.

In some embodiments, the concentration of the rheology modifier in the composition is 0.05-10% by weight based on the total weight of the composition. In some embodiments, the concentration of the rheology modifier in the composition is 1-6% by weight based on the total weight of the composition. In some embodiments, the concentration of the rheology modifier in the composition is 2-5% by weight based on the total weight of the composition. In some embodiments, the concentration of the rheology modifier in the composition is about 2.5% by weight based on the total weight of the composition. In some embodiments, the concentration of the rheology modifier in the composition is about 5% by weight based on the total weight of the composition. In some embodiments, the concentration of the rheology modifier in the composition is 4-6% by weight based on the total weight of the composition. In some embodiments, the concentration of the rheology modifier in the composition is 4.5-5.5% by weight based on the total weight of the composition. In some embodiments, the concentration of the rheology modifier in the composition is about 4% by weight based on the total weight of the composition. In some embodiments, the concentration of the rheology modifier in the composition is about 5% by weight based on the total weight of the composition.

In some embodiments, the composition comprises at least one thickener and at least one biocide. In some embodiments, the amount of the thickener and the biocide in the composition is up to 8% by weight based on the total weight of the composition. In some embodiments, the amount of the thickener and the biocide in the composition is up to 7% by weight based on the total weight of the composition. In some embodiments, the amount of the thickener and the biocide in the composition is up to 6% by weight based on the total weight of the composition. In some embodiments, the amount of the thickener and the biocide in the composition is up to 5% by weight based on the total weight of the composition. In some embodiments, the amount of the thickener and the biocide in the composition is up to 1% by weight based on the total weight of the composition.

In some embodiments, the amount of the thickener and the biocide in the composition is 3-6% by weight based on the total weight of the composition. In some embodiments, the amount of the thickener and the biocide in the composition is about 4% by weight based on the total weight of the composition. In some embodiments, the amount of the thickener and the biocide in the composition is about 5% by weight based on the total weight of the composition.

In some embodiments, the agriculturally acceptable additive is a preservative. In some embodiments, the composition comprises at least one preservative.

In some embodiments, the preservative is a biocide. In some embodiments, the composition comprises at least one biocide.

In some embodiments, the concentration of the preservative in the composition is 0.01-5% by weight based on the total weight of the composition. In some embodiments, the concentration of the preservative in the composition is 0.01-1% by weight based on the total weight of the composition. In some embodiments, the concentration of the preservative in the composition is 0.05-0.1% by weight based on the total weight of the composition. In some embodiments, the concentration of the preservative in the composition is about 0.1% by weight based on the total weight of the composition. In some embodiments, the concentration of the preservative in the composition is about 0.08% by weight based on the total weight of the composition.

In some embodiments, the composition comprises at least one additional bioactive ingredient, preferably an additional insecticide, fungicide and/or herbicide. In some embodiments, the additional bioactive ingredient(s) in the composition is fenpropidin. In some embodiments, the additional bioactive ingredient(s) in the composition is difenoconazole. In some embodiments, the additional bioactive ingredient(s) in the composition is tebuconazole. In some embodiments, the additional bioactive ingredient(s) in the composition is prothioconazole. In some embodiments, the additional bioactive ingredient(s) in the composition are prothioconazole and fluxapyroxad. In some embodiments, the additional bioactive ingredient(s) in the composition are tebuconazole and fluxapyroxad. In some embodiments, the additional bioactive ingredient(s) in the composition are difenoconazole and fluxapyroxad. In some embodiments, the additional bioactive ingredient(s) in the composition are prothioconazole and picoxystrobin. In some embodiments, the additional bioactive ingredient(s) in the composition are tebuconazole and picoxystrobin. In some embodiments, the additional bioactive ingredient(s) in the composition are difenoconazole and picoxystrobin. In some embodiments, the additional bioactive ingredient(s) in the composition are fenpropidin and picoxystrobin. In some embodiments, the additional bioactive ingredient(s) in the composition are fenpropidin and fluxapyroxad. In some embodiments, the additional bioactive ingredient(s) in the composition are prothioconazole and trifloxystrobin. In some embodiments, the additional bioactive ingredient(s) in the composition are cyproconazole and azoxystrobin. In some embodiments, the additional bioactive ingredient(s) in the composition are cyproconazole and picoxystrobin. In some embodiments, the additional bioactive ingredient(s) in the composition are tebuconazole and picoxystrobin. In some embodiments, the composition comprises a water immiscible carrier which comprises the additional bioactive ingredient(s). In some embodiments, the composition comprises an organic phase. In some embodiments, the composition comprises an organic phase which comprises a water immiscible carrier, and the water immiscible carrier comprises the additional bioactive ingredient(s). In some embodiments, the additional bioactive ingredient(s) is dissolved in the water immiscible carrier. In some embodiments, the additional bioactive ingredient(s) is suspended in the water immiscible carrier. In some embodiments, the additional bioactive ingredient(s) is suspended in the aqueous carrier.

In some embodiments, the dithiocarbamate fungicide is suspended in the aqueous carrier and the additional bioactive ingredient(s) is dissolved in the organic phase and/or suspended in the aqueous carrier. In some embodiments, the dithiocarbamate fungicide is suspended in the aqueous carrier and the additional fungicides are dissolved in the organic phase and suspended in the aqueous carrier. In some embodiments, the dithiocarbamate fungicide is suspended in the aqueous carrier and the additional fungicide is dissolved in the organic phase. In some embodiments, the dithiocarbamate fungicide is suspended in the aqueous carrier and the additional fungicide(s) is suspended in the aqueous carrier.

In some embodiments, the composition is substantially free of an agriculturally acceptable organic solvent. In some embodiments, the composition is aqueous.

In some embodiments, the composition is a suspension concentrate.

In some embodiments, the composition comprises:
a. 28-37% w/w of mancozeb,
b. 0.3-1.2% w/w of polycation,
c. 2-2.5% w/w of polyanion,
d. 4-4.5% w/w of anti-freeze agent,
e. 0.2-0.7% w/w of silicone-based anti-foam agent,
f. 1.5-3.5% w/w of dispersant,
g. 1.5-3.5% w/w of wetting agent,
h. 0.05-0.1% w/w of biocide,
i. 4.5-5.5% w/w of rheology modifier, and
j. 45-55% w/w of water.

In some embodiments, the composition comprises:
a. 28-32% w/w of mancozeb,
b. 0.3-0.7% w/w of chitosan,
c. 2-2.5% w/w of calcium lignosulfonate,
d. 4-4.5% w/w of propylene glycol,
e. 0.3-0.7% w/w of silicone-based anti-foam agent,
f. 2-2.5% w/w of modified styrene acrylic polymer,
g. 2-2.5% w/w of polyalkylene oxide block copolymer,
h. 0.05-0.1% w/w of biocide,
i. 5-5.5% w/w of rheology modifier, and
j. 50-55% w/w of water.

In some embodiments, the suspension concentrate comprises:
a. 30% w/w of mancozeb,
b. 0.5% w/w of chitosan,
c. 2.3% calcium lignosulfonate,
d. 4.1% w/w of propylene glycol,
e. 0.5% w/w of silicone-based anti-foam agent,
f. 2.1% w/w of a modified styrene acrylic polymer,
g. 2.1% w/w of a polyalkylene oxide block copolymer,
h. 0.084% w/w of a biocide,
i. 5.2% w/w of rheology modifier, and
j. 53% w/w of water.

In some embodiments, the composition comprises:
a. 30% w/w of mancozeb,
b. 0.5% w/w of chitosan,
c. 2.3% calcium lignosulfonate,
d. 4.1% w/w of propylene glycol,
e. 0.5% w/w of silicone-based anti-foam agent,
f. 2.1% w/w of a modified styrene acrylic polymer,
g. 2.1% w/w of a polyalkylene oxide block copolymer,
h. 0.084% w/w of a biocide,
i. 5.2% w/w of rheology modifier, and
j. 53% w/w of water.

In some embodiments, the composition comprises:
a. 28-32% w/w of mancozeb,
b. 0.8-1.2% w/w of PAA,
c. 2-2.5% calcium lignosulfonate,
d. 4-4.5% w/w of propylene glycol,
e. 0.3-0.7% w/w of silicone-based anti-foam agent,
f. 2-2.5% w/w of modified styrene acrylic polymer,
g. 2-2.5% w/w of polyalkylene oxide block copolymer,
h. 0.05-0.1% w/w of biocide,
i. 4.5-5.5% w/w of rheology modifier, and
j. 50-55% w/w of water.

In some embodiments, the composition comprises:
a. 30% w/w of mancozeb,
b. 1% w/w of PAA,
c. 2.3% calcium lignosulfonate,
d. 4.1% w/w of propylene glycol,
e. 0.5% w/w of silicone-based anti-foam agent,
f. 2.10% w/w of modified styrene acrylic polymer,
g. 2.1% w/w of polyalkylene oxide block copolymer,
h. 0.081% w/w of biocide,
i. 5% w/w of rheology modifier, and
j. 53% w/w of water.

In some embodiments, the composition comprises:
a. 30-35% w/w of mancozeb,
b. 0.7-1.1% w/w of PAA,
c. 2-2.5% calcium lignosulfonate,
d. 4-4.5% w/w of propylene glycol,
e. 0.2-0.6% w/w of silicone-based anti-foam agent,
f. 1.5-2.5% w/w of modified styrene acrylic polymer,
g. 1.5-2.5% w/w of polyalkylene oxide block copolymer,
h. 0.05-0.1% w/w of biocide,
i. 4.5-5.5% w/w of rheology modifier, and
j. 48-53% w/w of water.

In some embodiments, the composition comprises:
a. 32.6% w/w of mancozeb,
b. 0.9% w/w of PAA,
c. 2.3% calcium lignosulfonate,
d. 4.2% w/w of propylene glycol,
e. 0.4% w/w of silicone-based anti-foam agent,
f. 2% w/w of modified styrene acrylic polymer,
g. 2% w/w of polyalkylene oxide block copolymer,
h. 0.08% w/w of biocide,
i. 5% w/w of rheology modifier, and
j. 50.5% w/w of water.

In some embodiments, the composition comprises:
a. 33-37% w/w of mancozeb,
b. 0.7-1.1% w/w of PAA,
c. 2-2.5% calcium lignosulfonate,
d. 4-4.5% w/w of propylene glycol,
e. 0.2-0.6% w/w of silicone-based anti-foam agent,
f. 2.5-3.5% w/w of modified styrene acrylic polymer,
g. 2.5-3.5% w/w of polyalkylene oxide block copolymer,
h. 0.05-0.1% w/w of biocide,
i. 4.5-5.5% w/w of rheology modifier, and
j. 45-50% w/w of water.

In some embodiments, the composition comprises:
a. 34.8% w/w of mancozeb,
b. 0.9% w/w of PAA,
c. 2.3% calcium lignosulfonate,
d. 4.2% w/w of propylene glycol,
e. 0.4% w/w of silicone-based anti-foam agent,
f. 3% w/w of modified styrene acrylic polymer,
g. 3% w/w of polyalkylene oxide block copolymer,
h. 0.08% w/w of biocide,
i. 4% w/w of rheology modifier, and
j. 47.2% w/w of water.

In some embodiments, the composition comprises:
a. 34.8% w/w of mancozeb,
b. 0.5% w/w of chitosan,
c. 2.3% calcium lignosulfonate,
d. 4.2% w/w of propylene glycol,
e. 0.4% w/w of silicone-based anti-foam agent,
f. 3% w/w of modified styrene acrylic polymer,
g. 3% w/w of polyalkylene oxide block copolymer,
h. 0.08% w/w of biocide,
i. 4% w/w of rheology modifier, and
j. 47.6% w/w of water.

A composition according to the invention provides a stable aqueous suspension comprising a high concentration of a dithiocarbamate fungicide, preferably mancozeb, up to about 30% (w/v), with improved fungicidal activity compared to commercially available formulations of said dithiocarbamate fungicide, in the presence of relatively low amounts of adjuvants as agriculturally acceptable carriers.

A composition according to the invention may comprise an additional bioactive ingredient, also termed additional agrochemical, such as a growth regulator, a bio-stimulant, a fungicide, a herbicide, an insecticide, an acaricide, a molluscicide, a miticide, a rodenticide; and/or an bactericide.

In some embodiments, the composition or delivery system is tank mixed with an additional agrochemical. In some embodiments, the composition or delivery system is applied sequentially with the additional agrochemical. In some embodiments, the composition or delivery system is applied simultaneously with the additional agrochemical.

A composition according to the invention may further comprise at least one pH adjuster or buffering agent such as organic or inorganic bases and/or organic or inorganic acids.

In some embodiments, the composition may be a part of a suspoemulsion (SE).

In some embodiments, the composition is stable. In some embodiments, the stable composition is a stable suspension concentrate composition.

Aqueous concentrate is a type of composition. In some embodiments, the stable composition is a stable aqueous concentrate composition.

In some embodiments, the composition of the present invention comprises solid particles.

In some embodiments, the solid particles are solid particles of mancozeb. In some embodiments, the solid particles contain a mixture of mancozeb and at least one other compound.

In some embodiments, the composition comprises solid particles having d50 of 2 microns or less. In some embodiments, the composition comprises solid particles having d50 of 1-2 microns. In some embodiments, the composition comprises solid particles having d50 of 1-1.5 microns. In some embodiments, the composition comprises solid particles having d50 of 1.5-2 microns. In some embodiments, the composition comprises solid particles having d50 of about 1 micron. In some embodiments, the composition comprises solid particles having d50 of about 1.5 microns. In some embodiments, the composition comprises solid particles having d50 of about 2 microns.

In some embodiments, the composition comprises solid particles having d90 of 10 microns or less. In some embodiments, the composition comprises solid particles having d90 of 2.1-10 microns. In some embodiments, the composition comprises solid particles having d90 of 2.5-10 microns. In some embodiments, the composition comprises solid particles having d90 of 2.5-5 microns. In some embodiments, the composition comprises solid particles having d90 of 5-7.5 microns. In some embodiments, the composition comprises solid particles having d90 of 7.5-10 microns. In some embodiments, the composition comprises solid particles having d90 of about 2.5 microns. In some embodiments, the composition comprises solid particles having d90 of about 4 microns. In some embodiments, the composition comprises solid particles having d90 of about 6 microns.

In some embodiments, the composition comprises solid particles having d99 of 20 microns or less. In some embodiments, the composition comprises solid particles having d99 of 10-20 microns. In some embodiments, the composition comprises solid particles having d99 of 10-15 microns. In some embodiments, the composition comprises solid particles having d99 of 15-20 microns. In some embodiments, the composition comprises solid particles having d99 of about 15 microns.

In some embodiments, the composition has a viscosity of 1000 mPas or less (Brockfield SP63—60 rpm). In some embodiments, the composition has a viscosity of 500 mPas or less (Brockfield SP63—60 rpm). In some embodiments, the composition has a viscosity of 100 mPas or less (Brockfield SP63—60 rpm). In some embodiments, the composition has a viscosity of 50-1000 mPas or less (Brockfield SP63—60 rpm). In some embodiments, the composition has a viscosity of 50-500 mPas or less (Brockfield SP63—60 rpm). In some embodiments, the composition has a viscosity of 300-800 mPas or less (Brockfield SP63—60 rpm).

The amount of mancozeb in the composition may affect the viscosity of the composition. Based on the amount of mancozeb in the composition, the surfactant(s) may be selected and the amount of the surfactant(s) may be adjusted to achieve the desired viscosity, preferably 1000 mPas or less (Brockfield SP63—60 rpm).

In some embodiments, the composition comprises greater than 25% by weight of mancozeb and the viscosity of the composition is 1000 mPas or less (Brockfield SP63—60 rpm). In some embodiments, the composition comprises greater than 30% by weight of mancozeb and the viscosity of the composition is 1000 mPas or less (Brockfield SP63—60 rpm). In some embodiments, the composition comprises greater than 35% by weight of mancozeb and the viscosity of the composition is 1000 mPas or less (Brockfield SP63—60 rpm). Preferred surfactant(s), combinations thereof, and amounts thereof are described herein.

Each embodiment disclosed herein is contemplated as being applicable to each of the other disclosed embodiments. Thus, all combinations of the various elements described herein are within the scope of the invention. The elements recited in composition embodiments can be used with the suspension concentrate, aqueous concentrate, and suspoemulsion described herein and vice versa.

### 3.3 A Polyelectrolyte Complex

The composition of the present invention comprises a polyelectrolyte complex.

In some embodiments, the polyelectrolyte complex is a complex of a polycation and a polyanion.

A non-bioactive polycation is preferably or comprises cationic starch, poly(allylamine), chitosan, a chitosan derivative such as thiolated chitosan, 5-methyl-pyrrolidinone-chitosan, and chitosan oligosaccharide, epsilon-p-L-lysine, DEAE-dextran, or mixtures thereof. Preferably, said non-bioactive polycation is selected from the group consisting of cationic starch, poly(allylamine), chitosan and chitosan derivatives. Preferably, said non-bioactive polycation is poly(allylamine). Preferably, said non-bioactive polycation is chitosan.

In some embodiments, the preferred polycation in a polyelectrolyte complex according to the invention is cationic derivative of starch, poly(allylamine), chitosan, epsilon-poly (L-lysine), chitosan derivatives such as thiolated chitosan, 5-methyl-pyrrolidinone-chitosan and chitosan oligosaccharide and/or DEAE-dextran.

In some embodiments, the preferred polyanion in a polyelectrolyte complex according to the invention is a negatively charged derivative of natural origin, for example, xanthan gum, alginate, a lignin compound such as lignosulfonate, pectin, carrageenan, humic acid, fulvic acid, angico gum, gum Kondagogu, sodium alkyl naphtalene sulfonate (Morwet), poly-γ-glutamic acid, maleic starch half-ester, carboxymethyl cellulose, dextran sulphate, hyaluronic acid, poly(acrylic acid), polyphosphoric acid, poly(L-lactide), polyglycolide, sodium (Na) humate, and/or chondroitin sulfate (CS).

In some embodiments, the polycation is selected from the group consisting of chitosan (CTS), epsilon-poly-L-lysine (ϵ-PLL), poly allyl amine (PAA), and any mixture thereof. In some embodiments, the polycation is chitosan (CTS). In some embodiments, the polycation is poly allyl amine (PAA). In some embodiments, the polycation is epsilon-poly-L-lysine (ϵ-PLL).

In some embodiments, the polycation is chitosan, epsilon-poly (L-lysine), PAA or any combination thereof.

In some embodiments, the polycation is chitosan and/or poly allyl amine (PAA).

In some embodiments, the polycation is chitosan, poly allyl amine (PAA) and combination thereof.

In some embodiments, the polycation is chitosan.

In some embodiments, the polycation is PAA.

A non-bioactive polyanion is preferably of natural origin, for example xanthan gum, alginate, pectin, a lignin compound such as lignosulfonate, carrageenan, humic acid, fulvic acid, angico gum, gum Kondagogu, sodium alkyl naphtalene sulfonate, poly-γ-glutamic acid, maleic starch half-ester, carboxymethyl cellulose, chondroitin sulphate, dextran sulphate, or hyaluronic acid, or of synthetic origin, for example poly(acrylic acid), polyphosphoric acid, and poly(L-lactide), or a mixture thereof, to form a polyelectrolyte complex with a non-bioactive polycation. Preferably, said non-bioactive polyanion is selected from the group consisting of xanthan gum, alginate sodium (Na), chondroitin sulfate (CS), lignosulfonate and any combination thereof. Most preferably, said non-bioactive polyanion comprises or is lignosulfonate.

In some embodiments, the polyanion is lignosulfonate.

In some embodiments, the polyanion of the polyelectrolyte complex is lignosulfonate and the dispersant of the aqueous composition is also lignosulfonate.

Sodium (Na) humate, a water-soluble Na salt of humic acid derived from leonardite (an oxidation product of lignite), was chosen as the preconditioning polyelectrolyte. Na humate is a commercially available low-cost material that is increasingly used in biological farming as a soil conditioner, and also to stimulate plant growth.

Sodium humate forms complexes/chelates with cationic dye/metal ions due to the presence of these carboxylate and phenolate groups.

Chondroitin sulfate (CS) is one of the natural glycosaminglycans (GAG) composed of the alternating sugars D-glucuronic acid (GlcA) and N-acetyl-D-galactosamine (GalNAc). It is an important component of the extracellular complex (ECM). Due to the negative charge of CS is considered a strong polyelectrolyte.

In some embodiments, the complex is characterized by a non-covalent intermolecular interactions, preferably ionic interaction and hydrogen bonds between donor and acceptor groups of said polycation and said polyanion.

The polyelectrolyte complex is prepared by mixing at least one polyanion and at least one polycation.

In some embodiments, the polycation is protonated prior to interaction with the polyanion.

In some embodiments, the polyanion is prepared prior to the interaction with the polycation.

In some embodiments, the polyelectrolyte complex is prepared as described in WO2013/133705 and WO2013/133706.

In some embodiments, the concentration of the polycation in the polyelectrolyte complex is 0.01-5% by weight based on the total weight of the composition. In some embodiments, the concentration of the polycation in the polyelectrolyte complex is 0.01-2% by weight based on the total weight of the composition. In some embodiments, the concentration of the polycation in the polyelectrolyte complex is about 0.5% by weight based on the total weight of the composition. In some embodiments, the concentration of the polycation in the polyelectrolyte complex is about 1% by weight based on the total weight of the composition.

In some embodiments, the concentration of chitosan in the polyelectrolyte complex is about 0.5% by weight based on the total weight of the composition.

In some embodiments, the concentration of PAA in the polyelectrolyte complex is about 0.5% by weight based on the total weight of the composition.

In some embodiments, the concentration of chitosan in the polyelectrolyte complex is about 1% by weight based on the total weight of the composition.

In some embodiments, the concentration of PAA in the polyelectrolyte complex is about 1% by weight based on the total weight of the composition.

In some embodiments, the concentration of the polyanion used for the polyelectrolyte complex is 0.01-10% by weight based on the total weight of the composition. In some embodiments, the concentration of the polyanion used for the polyelectrolyte complex is 0.01-8% by weight based on the total weight of the composition. In some embodiments, the concentration of the polyanion used for the polyelectrolyte complex is 0.1-5% % by weight based on the total weight of the composition.

In some embodiments, the concentration of the polyanion in the polyelectrolyte complex is 0.01-5% by weight based on the total weight of the composition. In some embodiments, the concentration of the polyanion in the polyelectrolyte complex is 1-3% by weight based on the total weight of the composition. In some embodiments, the concentration of the polyanion in the polyelectrolyte complex is about 2% by weight based on the total weight of the composition.

In some embodiments, the concentration of lignosulfonate in the polyelectrolyte complex is less than 3% by weight based on the total weight of the composition.

In some embodiments, the concentration of lignosulfonate in the polyelectrolyte complex is less than 2.5% by weight based on the total weight of the composition.

In some embodiments, the concentration of lignosulfonate in the polyelectrolyte complex is less than 2% by weight based on the total weight of the composition.

In some embodiments, the concentration of lignosulfonate in the polyelectrolyte complex is less than 1.5% by weight based on the total weight of the composition.

In some embodiments, the polyelectrolyte complex is free of lignosulfonate.

In some embodiments, the weight ratio between the polyanion and polycation used for the polyelectrolyte complex is between 10:1 to 1:2. In some embodiments, the weight ratio between the polyanion and polycation used for the polyelectrolyte complex is between 8:1 to 1:2. In some embodiments, the weight ratio between the polyanion and polycation used for the polyelectrolyte complex is between 5:1 to 1:2. In some embodiments, the weight ratio between the polyanion and polycation used for the polyelectrolyte complex is between 10:1 to 1:1. In some embodiments, the weight ratio between the polyanion and polycation used for the polyelectrolyte complex is between 5:1 to 1:1. In some embodiments, the weight ratio between the polyanion and polycation used for the polyelectrolyte complex is between 5:1 to 2:1. In some embodiments, the weight ratio between the polyanion and polycation used for the polyelectrolyte complex is 5:1. In some embodiments, the weight ratio between the polyanion and polycation used for the polyelectrolyte complex is about 2.3:1. In some embodiments, the weight ratio between the polyanion and polycation used for the polyelectrolyte complex is about 2.5:1. In some embodiments, the weight ratio between the polyanion and polycation used for the polyelectrolyte complex is about 4.6:1

In some embodiments, the concentration of the polyanion in the polyelectrolyte complex is less than 3% by weight based on the total weight of the composition. In some embodiments, the concentration of the polyanion in the polyelectrolyte complex is less than 2.5% by weight based on the total weight of the composition. In some embodiments, the concentration of the polyanion in the polyelectrolyte complex is less than 2% by weight based on the total weight of the composition. In some embodiments, the concentration of the polyanion in the polyelectrolyte complex is less than 1.5% by weight based on the total weight of the composition. In some embodiments, the concentration of the polyanion in the polyelectrolyte complex is less than 1% by weight based on the total weight of the composition. In some embodiments, the concentration of the polyanion in the polyelectrolyte complex is less than 0.5% by weight based on the total weight of the composition. In some embodiments, the concentration of the polyanion in the polyelectrolyte complex is 0.01-5% by weight based on the total weight of the composition. In some embodiments, the concentration of the polyanion in the polyelectrolyte complex is 1-3% by weight based on the total weight of the composition. In some embodiments, the concentration of the polyanion in the polyelectrolyte complex is about 2% by weight based on the total weight of the composition.

In some embodiments, the concentration of the polycation in the polyelectrolyte complex is 0.01-10% by weight based on the total weight of the composition. In some embodiments, the concentration of the polycation in the polyelectrolyte complex is 0.1-5% by weight based on the total weight of the composition. In some embodiments, the concentration of the polycation in the polyelectrolyte complex is 0.1-1.5% by weight based on the total weight of the composition. In some embodiments, the concentration of the polycation in the polyelectrolyte complex is about 0.5% by weight based on the total weight of the composition. In some embodiments, the concentration of the polycation in the polyelectrolyte complex is about 0.5% by weight based on the total weight of the composition. In some embodiments, the concentration of the polycation in the polyelectrolyte complex is about 1% by weight based on the total weight of the composition. In some embodiments, the concentration of the polycation in the polyelectrolyte complex is 0.01-5% by weight based on the total weight of the composition. In some embodiments, the concentration of the polycation in the polyelectrolyte complex is 0.01-2% by weight based on the total weight of the composition. In some embodiments, the concentration of the polycation in the polyelectrolyte complex is about 0.5% by weight based on the total weight of the composition. In some embodiments, the concentration of the polycation in the polyelectrolyte complex is about 1% by weight based on the total weight of the composition.

### 3.4 Additional Bioactive

Various agrochemicals may be used as additional bioactive ingredient. Exemplary among such agrochemicals without limitation are crop protection agents, for example pesticides, safeners, plant growth regulators, repellents, bio-stimulants and preservatives such as bacteriostats or bactericides.

A composition of the invention may also comprise two or more additional bioactive ingredients, such as two or more fungicides, two or more herbicides, two or more insecticides, two or more acaricides, two or more bactericides, or combinations thereof, such as at least one antifungal compound and at least one insecticide, at least one antifungal compound and at least one herbicide, at least one antifungal compound and at least one acaricide, at least one antifungal compound and at least one bactericide, at least one herbicide and at least one insecticide, at least one herbicide and at least one acaricide, at least one herbicide and at least one bactericide, at least one insecticide and at least one acaricide, at least one insecticide and at least one bactericide, and at least one acaricide and at least one bactericide. Some bioactive ingredients have a wide range of target organisms, as is known to the skilled person, and are therefore include in more than one subgroup of bioactive ingredients. Said at least one additional bioactive ingredient preferably is present in a concentration of between 0.1 and 90 w/v %, more preferred between 1 and 70 w/v %, more preferred between 10 and 50 w/v %.

Said additional bioactive ingredient preferably is an insecticide, a fungicide and/or an herbicide.

A preferred additional insecticide is a carbamate such as carbofuran, propoxur, methomyl, bendiocarb, formetanate, oxamyl, and aldicarb, an organochlorine such as methoxychlor, kelthane, lindane, toxaphene, and cyclodiene insecticides such as aldrin, dieldrin, endrin, mirex, chlordane, heptachlor, and endosulfan, an organophosphate such as parathion, malathion, methyl parathion, chlorpyrifos, diazinon, dichlorvos, phosmet, fenitrothion, tetrachlorvinphos, azamethiphos, azinphos-methyl, and terbufos, a formamidine such as amitraz, chlordimeform, formetanate, formparanate, medimeform, and semiamitraz, an organosulfur such as dipymetitrone, an avermectin such as ivermectin, doramectin, selamectin, milbemycin oxime and moxidectin, a neonicotinoid such as acetamiprid, clothianidine, imidacloprid, nitenpyram, nithiazine, thiacloprid and thiamethoxam and/or a pyrethroid insecticide such as allethrin, bifenthrin, cyfluthrin, cypermethrin, cyphenothrin, deltamethrin, esfenvalerate, etofenprox, fenpropathrin, fenvalerate, flucythrinate, flumethrin, fmiprothrin, lambda-cyhalothrin, metofluthrin, permethrin, resmethrin, silafluofen, sumithrin, tau-fluvalinate, tefluthrin, tetramethrin, tralomethrin, and transfluthrin.

A preferred additional fungicide is selected from sodium ortho-phenylphenate, 2-phenylphenol; 8-hydroxyquinoline sulphate; acibenzolar-5-methyl; actinovate; aldimorph; amidoflumet; ampropylfos; ampropylfos-potassium; andoprim; anilazine; azoxystrobin; benalaxyl; benodanil; benomyl (methyl 1-(butylcarbamoyl)benzimidazol-2-ylcarbamate); benthiavalicarb-isopropyl; benzamacril; benzamacril-isobutyl; bilanafos; binapacryl; biphenyl; blasticidin-S; boscalid; bupirimate; buthiobate; butylamine; calcium polysulphide; capsimycin; captafol; captan (N-(trichloromethylthio)cyclohex-4-ene-1,2-dicarboximide); carbendazim; carboxin; carpropamid; carvone; chinomethionat; chlobenthiazone; chlorfenazole; chloroneb; chlorothalonil; chlozolinate; cis-1-(4-chlorophenyl)-2-(1H-1,2,4-triazol-1-yl)-cycloheptanol; clozylacon; a conazole fungicide such as, for example, (RS)-1-(β-allyloxy-2,4-dichlorophenethyl)imidazole (imazalil; Janssen Pharmaceutica NV, Belgium) and N-propyl-N-[2-(2,4,6-trichlorophenoxy)ethyl] imidazole-1-carboxamide (prochloraz); cyazofamid; cyflufenamid; cymoxanil; cyprodinil; cyprofuram; Dagger G; debacarb; dichlofluanid; dichlone; dichlorophen; diclocymet; diclomezine; dicloran; diethofencarb; diflumetorim; dimethirimol; dimethomorph; dimoxystrobin; dinocap; diphenylamine; dipyrithione; ditalimfos; dithianon; dodine; drazoxolon; edifenphos; ethaboxam; ethirimol; etridiazole; famoxadone; fenamidone; fenapanil; fenfuram; fenhexamid; fenitropan; fenoxanil; fenpiclonil; fenpropidin; fenpropimorph; fluazinam (3-chloro-N-(3-chloro-5-trifluoromethyl-2-pyridyl)-α,α,α-trifluoro-2,6-dinitro-p-toluidine); flubenzimine; fludioxonil; flumetover; flumorph; fluoromide; fluoxastrobin; flurprimidol; flusulfamide; flutolanil; folpet (N-(trichloromethylthio)phthalimide); fosetyl-A1; fosetyl-sodium; fuberidazole; furalaxyl; furametpyr; furcarbanil; furmecyclox; guazatine; hexachlorobenzene; hymexazol; iminoctadine triacetate; iminoctadine tris(albesilate); iodocarb; iprobenfos; iprodione; iprovalicarb; irumamycin; isoprothiolane; isovaledione; kasugamycin; kresoxim-methyl; mandipropamid, meferimzone; mepanipyrim; mepronil; metalaxyl; metalaxyl-M; methasulfocarb; methfiroxam; methyl 1-(2,3-dihydro-2,2-dimethyl-1H-inden-1-yl)-1H-imidazole-5-carboxylate; methyl 2-[[[cyclopropyl[(4-methoxyphenyl)imino]methyl]thio]-methyl]-.alph-a.-(methoxymethylene)benzeneacetate; methyl 2-[2-[3-(4-chlorophenyl)-1-methyl-allylideneaminooxymethyl]phenyl]-3-meth-oxyacrylate; metiram; metominostrobin; metrafenone; metsulfovax; mildiomycin; monopotassium carbonate; myclozolin; N-(3-ethyl-3,5,5-trimethylcyclohexyl)-3-formylamino-2-hydroxybenzamide; N-(6-methoxy-3-pyridinyl)cyclopropanecarboxamide; a polyene fungicide such as natamcyin; N-butyl-8-(1,1-dimethylethyl)-1-oxaspiro[4.5]decan-3-amine; nitrothal-isopropyl; noviflumuron; ofurace; orysastrobin; oxadixyl; oxolinic acid; oxycarboxin; oxyfenthiin; pencycuron; penthiopyrad; phosdiphen; phosphite salts such as disodium phosphite and potassium phosphite, phthalide; picobenzamid; picoxystrobin; piperalin; polyoxins; polyoxorim; procymidone; propamocarb; propanosine-sodium; propineb; proquinazid; pyraclostrobin; pyrazophos; pyrimethanil; pyroquilon; pyroxyfur; pyrrolnitrine, quinconazole; quinoxyfen; quintozene; silthiofam; sodium tetrathiocarbonate; spiroxamine; sulphur; tecloftalam; tecnazene; tetcyclacis; thiazole fungicide such as, for example, 2-(thiazol-4-yl)benzimidazole (thiabendazole), thicyofen; thifluzamide; thiophanate-methyl; tiadinil; tioxymid; tolclofos-methyl; tolylfluanid; triazbutil; triazoxide; tricyclamide; tricyclazole; tridemorph; trifloxystrobin; validamycin A; vinclozolin; zoxamide; (2S)— N-[2-[4-[[3-(4-chlorophenyl)-2-propynyl]oxy]-3-methoxyphenyl]ethyl]-3-met-hyl-2-[(methylsulphonyl)amino]butanamide; 1-(1-naphthalenyl)-1H-pyrrole-2,5-dione; 2,3,5,6-tetrachloro-4-(methylsulphonyl)pyridine; 2,4-dihydro-5-methoxy-2-methyl-4-[[[[l1-[3-(trifluoromethyl)phenyl]-ethyli-dene]amino]oxy]methyl]phenyl]-3H-1,2,3-triazol-3-one; 2-amino-4-methyl-N-phenyl-5-thiazolecarboxamide; 2-chloro-N-(2,3-dihydro-1,1,3-trimethyl-1H-inden-4-yl)-3-pyridinecarboxam-ide; 3,4,5-trichloro-2,6-pyridinedicarbonitrile; 3-[(3-bromo-6-fluoro-2-methyl-1H-indol-1-yl)sulphonyl]-N,N-dimethyl-1H-1-2,4-triazole-1-sulphonamide, and/or mixtures thereof.

A most preferred additional fungicide is natamycin. A composition of the invention may also comprise two or more additional fungicides, such as, for example, natamycin and a strobilurin type of fungicides such as azoxystrobin, natamycin and a triazole type of fungicides such as cyproconazole, natamycin and a succinate dehydrogenase inhibitor type of fungicides such as boscalid, natamycin and a pthalimide/pthalonitrile type of fungicide such as chlorothalonil, natamycin and captan, natamycin and a benzimidazole type of fungicide such as thiabendazole, natamycin and a carbamate type of fungicides such as propamocarb, natamycin and a carboxamide type of fungicides such as fenoxanil, natamycin and a dicarboxamide type of fungicide such as iprodione, natamycin and a morpholine type of fungicide such as dimethamorph, natamycin and an organophosphate type of fungicide such as fosetyl, natamycin and an azole type of fungicide such as prothioconazole, natamycin and a phenylamide type of fungicide suich as metalaxyl, natamycin and a fungicide not belonging to a specific group of fungicides such as fludioxynil and/or folpet.

A preferred additional herbicide is selected from an inhibitor of amino acid synthesis such as inhibitors of 5-enolpyruvyl-shikimate-3-phosphate synthase, acetolactate synthase and glutamine synthetase such as a glyphosate, a sulfonylurea, an imidazolinone, a glufosinate and/or a 1,2,4-triazol [1,5A] pyrimidine; a photosynthetic inhibitor that binds D-1:quinone-binding protein, including anilides, benzimidazoles, biscarbamates, pyridazinones, triazinediones, triazines, triazinones, uracils, substituted ureas, quinones, hydroxybenzonitriles, and several unclassified heterocycles; inhibitors of acetyl-CoA carboxylase such as aryloxyphenoxy alkanoic acids and cyclohexanediones; inhibitors of cellular division such as phosphoric amide and dinitroaniline; inhibitors of the terpenoid synthesis pathway such as substituted pyridazinones, m-phenoxybenzamides, fluridone, difunone, 4-hydroxypyridine, aminotriazole amitrole, 6-methyl pyrimidine, isoxazolidinone; inhibitors of dihydropteroate synthase such as asulam, and/or mixtures thereof.

Such preferred additional herbicide is preferably selected from benzobicyclon, mesotrione, sulcotrione, tefuryltrione, tembotrione, 2,4-dichlorophenoxyacetic acid, 3,6-dichloro-2-methoxybenzoic acid (dicamba), 4-hydroxy-3-[[2-(2-methoxyethoxy)methyl]-6-(trifluoromethyl)-3-pyridinyl]carbonyl]-bicyclo[3.2.1]-oct-3-en-2-one (bicyclopyrone), ketospiradox or the free acid thereof, benzofenap, pyrasulfotole, pyrazolynate, pyrazoxyfen, topramezone, [2-chloro-3-(2-methoxyethoxy)-4-(methylsulfonyl)phenyl](1-ethyl-5-hydroxy-1H-pyrazol-4-yl)-methanone, (2,3-dihydro-3,3,4-trimethyl-1, 1-dioxidobenzo[b]thien-5-yl)(5-hydroxy-1-methyl-1H-pyrazol-4-yl)-methanone, isoxachlortole, isoxaflutole, a-(cyclopropylcarbonyl)-2-(methylsulfonyl)-oxo-4-chloro-benzenepropanenitrile, and a-(cyclopropylcarbonyl)-2-(methylsulfonyl)-oxo-4-(trifluoromethyl)-benzenepropanenitrile.

Preferred combinations with the present invention are dimethomorph, cymoxanil, carbendazim, imidacloprid, zoxamide and metalaxyl.

Preferred additional pesticides which may be combined with a composition of the present invention are one or more of dimethomorph, cymoxanil, carbendazim, imidacloprid, zoxamide and metalaxyl.

In some embodiments, the additional fungicides are strobilurin fungicide and azole fungicides. In some embodiments, the additional fungicides are a carboxamides/SDHI and/or a morpholine. In some embodiments, the additional fungicides are selected from the group consisting of strobilurin fungicide, azole fungicides, carboxamides/SDHI, morpholines, and any combination thereof.

Strobilurin fungicide may be but is not limited to picoxystrobin.

Azole fungicide may be, but is not limited to, tebuconazole, prothioconazole, or a combination thereof.

In some embodiments, the composition of the present invention is combined with two additional fungicides. In some embodiments, the composition of the present invention is combined with are picoxystrobin and tebuconazole. In some embodiments, the composition of the present invention is combined with are picoxystrobin and prothioconazole. In some embodiments, the composition of the present invention is combined with picoxystrobin and tebuconazole. In some embodiments, the composition of the present invention is combined with prothioconazole.

In some embodiments, the composition of the present invention is combined with fenpropidin. In some embodiments, the composition of the present invention is combined with difenoconazole. In some embodiments, the composition of the present invention is combined with tebuconazole. In some embodiments, the composition of the present invention is combined with prothioconazole. In some embodiments, the composition of the present invention is combined with prothioconazole and fluxapyroxad. In some embodiments, the composition of the present invention is combined with tebuconazole and fluxapyroxad. In some embodiments, the composition of the present invention is combined with difenoconazole and fluxapyroxad. In some embodiments, the composition of the present invention is combined with prothioconazole and picoxystrobin. In some embodiments, the composition of the present invention is combined with tebuconazole and picoxystrobin. In some embodiments, the composition of the present invention is combined with difenoconazole and picoxystrobin. In some embodiments, the composition of the present invention is combined with fenpropidin and picoxystrobin. In some embodiments, the composition of the present invention is combined with fenpropidin and fluxapyroxad. In some embodiments, the composition of the present invention is combined with prothioconazole and trifloxystrobin. In some embodiments, the composition of the present invention is combined with cyproconazole and azoxystrobin. In some embodiments, the composition of the present invention is combined with cyproconazole and picoxystrobin. In some embodiments, the composition of the present invention is combined with picoxystrobin and tebuconazole.

### 3.5 Methods for Preparation of an Aqueous Concentrate Composition

The invention provides a process for producing an aqueous composition according to the present invention, wherein the process comprises the following steps:

(a) obtaining the polyelectrolyte complex,

(b) mixing the polyelectrolyte complex obtained in step (a) with dithiocarbamate fungicide and agriculturally acceptable additive.

The invention also provides a process for preparing a composition according to the present invention, wherein the process comprises (a) preparing an aqueous composition of a polyelectrolyte complex, (b) mixing a dithiocarbamate fungicide into the aqueous composition, and (c) adding agriculturally acceptable additive(s).

In some embodiments, the agriculturally acceptable additive is a surfactant.

In some embodiments, the surfactant(s) is a dispersant and/or a wetting agent.

In some embodiments, the surfactants are a dispersant and a wetting agent.

The invention further provides a process for preparing a composition according to the present invention, wherein the process comprises (a) preparing an aqueous composition of a polyelectrolyte complex, (b) mixing a dithiocarbamate fungicide into the aqueous composition, and (c) adding agriculturally acceptable additive, wherein the adding agriculturally acceptable additive comprising dispersant selected from group consisting of a modified acrylic polymer, non-modified acrylic acid, sulfonate polymer and combination thereof.

The invention further provides a process for preparing a composition according to the present invention, wherein the process comprises (a) preparing an aqueous composition of a polyelectrolyte complex, (b) mixing a dithiocarbamate fungicide into the aqueous composition, and (c) adding agriculturally acceptable additives to the aqueous composition to prepare the composition according to the present invention, wherein the agriculturally acceptable additives comprises (i) a dispersant selected from group consisting of a modified acrylic polymer, non-modified acrylic acid, sulfonate polymer and any combination thereof, and (ii) a wetting agent, wherein the wetting agent is polyalkylene oxide block copolymer.

The invention further provides a process for preparing a composition according to the present invention, wherein the process comprises (a) preparing an aqueous composition of a polyelectrolyte complex, (b) adding agriculturally acceptable additives to the aqueous composition, and (c) mixing a dithiocarbamate fungicide into the aqueous composition to prepare the composition according to the present invention, wherein the agriculturally acceptable additives comprises (i) a dispersant selected from group consisting of a modified acrylic polymer, non-modified acrylic acid, sulfonate polymer and any combination thereof, and (ii) a wetting agent, wherein the wetting agent is polyalkylene oxide block copolymer.

In some embodiments, the dithiocarbamate fungicide and the agriculturally acceptable additive(s) are added alternately.

Adding dithiocarbamate fungicide and agriculturally acceptable additive affect the viscosity of the composition.

Said methods or processes for producing a composition according to the invention may further comprise adding an antifoaming agent.

Said methods or processes for producing a composition according to the invention may further comprise adding a rheology modifier.

Said methods or processes for producing a composition according to the invention may further comprise a step of milling or grinding the resultant composition to reduce their particle size to an average particle size (volume based) d50 below 2 microns.

The terms “preparing” and “producing” used in connection with a process are used interchangeably.

### 3.6 Methods of Use

The invention also provides a method of treating a plant, or a part of a plant, against a pathogen, comprising contacting the plant, or part of the plant, with a composition described herein.

In some embodiments, the method comprises protecting the plant, or a part of a plant, against the pathogen, comprising contacting the plant, or part of the plant, with the composition described herein.

In some embodiments, the method comprises preventing, reducing and/or eliminating the presence of the pathogen on the plant, or part of the plant, comprising contacting the plant, or part of the plant, with the composition described herein.

In some embodiment, the method of treating the plant, or the part of a plant against a pathogen comprises controlling diseases caused by phytopathogenic fungi in plants or on propagation material thereof, which method comprises contacting the plants, or propagation material thereof, with the composition described herein.

In some embodiments, the method comprises controlling pest comprising contacting (i) the pest or a locus thereof, (ii) a plant or a locus or propagation material thereof, (iii) soil, and/or (iv) an area in which pest infestation is to be prevented with a composition of the invention.

In some embodiments, the method comprises controlling unwanted insects comprising applying to an area infested with any one or any combination the compositions described herein.

In some embodiments, the method comprises improving pest control comprising applying any one of the compositions described herein to a plant/or soil.

In some embodiments, the method comprises pest control by preventive, curative and/or persistence treatment of a plant disease caused by phytopathologic fungi comprising contacting a plant, a locus thereof or propagation material thereof with an effective amount of any one of the herein disclosed composition comprising a dithiocarbamate fungicide.

An aspect of the invention provides a use of the composition according to the invention, comprising a dithiocarbamate fungicide and a polyelectrolyte complex, for increasing biological activity of the dithiocarbamate fungicide. Said use of a composition of the invention, comprising a dithiocarbamate fungicide and a polyelectrolyte complex, may result in a reduced rate of application of the dithiocarbamate fungicide.

The terms “reduced rate of application” and “increasing biological activity” may refer to a rate of application that is more than 20%, preferably more than 50%, reduced, when compared to the rate of application of the same dithiocarbamate fungicide as a free dithiocarbamate fungicide.

Said reduced rate of application may refer to an application rate of 5 mg dithiocarbamate fungicide (a.i.)/ha to 2.5 kg a.i./ha, preferably 1 g a.i./ha to 2 kg a.i./ha.; such as a rate of 750 g a.i./ha.; a rate of 605 g a.i./ha., a rate of 500 g a.i./ha.

In some embodiments, the composition is applied at an amount of 0.01-5 g/ha of the dithiocarbamate fungicide. In some embodiments, the composition is applied at an amount of 0.01-3 g/ha of the dithiocarbamate fungicide. In some embodiments, the composition is applied at an amount of 0.01-2 g/ha of the dithiocarbamate fungicide. In some embodiments, the composition is applied at an amount of 0.01-1 g/ha of the dithiocarbamate fungicide.

In some embodiments, the composition is applied at an amount of 0.01-5 g/ha of mancozeb. In some embodiments, the composition is applied at an amount of 0.01-3 g/ha of mancozeb. In some embodiments, the composition is applied at an amount of 0.01-2 g/ha of mancozeb. In some embodiments, the composition is applied at an amount of 0.01-1 g/ha of mancozeb.

In some embodiments, the composition is applied at an amount of 0.018 g/ha of mancozeb. In some embodiments, the composition is applied at an amount of 0.97 g/ha of mancozeb. In some embodiments, the composition is applied at an amount of 0.39 g/ha of mancozeb. In some embodiments, the composition is applied at an amount of 1.56 g/ha of mancozeb.

A composition according to the invention is suitable for the control of pests that are encountered in horticulture, agriculture, and forestry. The composition is active against normally sensitive and resistant pest species and during all or individual stages of development. Prior to use, a composition of the present invention is preferably dissolved or dispersed in water, or diluted with water, to provide an aqueous composition comprising between 0.001 and 10 w/v % of the dithiocarbamate fungicide. If required, an agriculturally acceptable carrier such as a sticking agent is added to the diluted aqueous composition.

A composition according to the invention is preferably diluted 2-5000 times, preferably about 200 times, with an aqueous solvent, preferably water, to contain between 0.0001 and 10% (w/v) of the dithiocarbamate fungicide, prior to contacting a plant, plant part or soil with the composition.

To control agricultural pests, the invention provides a use of a composition according to the invention for the protection of a plant, or a part of a plant, against a pathogen. In order to achieve this effect, said plant or plant part, or a soil, is contacted with said composition, including a diluted aqueous composition. Said composition is used, for example, to control powdery mildew and downy mildew infections on food/feed crops, including tree fruits, vegetable crops, field crops, grapes, ornamental plants, and sod farms. Further use, for example, is to control scab, including common scab, apple scab and black scab on potatoes, pear scab, and powdery scab, brown rot of peaches, currant and gooseberry leaf spot, peanut leafspot, and mildew on roses. Other uses include protection of greenhouse grown flowers and ornamentals, home vegetable gardens and residential turf. In addition, said composition, including a diluted aqueous composition, may be contacted with isolated fruits, nuts, vegetables, and/or flowers.

For said use and said methods, the composition, including a diluted aqueous composition, is preferably sprayed over a plant, or part thereof. Spraying applications using automatic systems are known to reduce labor costs and are cost-effective. Methods and equipment well-known to a person skilled in the art can be used for that purpose. The composition, including diluted aqueous composition, can be regularly sprayed, when the risk of infection is high. When the risk of infection is lower, spray intervals may be longer.

Other methods suitable for contacting plants or parts thereof with a composition of the invention are also a part of the present invention. These include, but are not limited to, dipping, watering, drenching, introduction into a dump tank, vaporizing, atomizing, fogging, fumigating, painting, brushing, misting, dusting, foaming, spreading-on, packaging and coating (e.g. by means of wax or electrostatically). In addition, the composition, including a diluted aqueous composition, may be injected into the soil.

For example, a plant of part thereof may be coated with a diluted aqueous composition comprising a dithiocarbamate fungicide according to the invention by submerging the plant or part thereof in a diluted aqueous composition to protect the plant of part thereof against a pathogen and/or to prevent, reduce and/or eliminate the presence of a pathogen on a plant, or a part of a plant. A preferred part of a plant that is coated with a composition according to the invention, or with a dilution thereof, is seed. A further preferred part of a plant that is coated with a composition according to the invention, or with a dilution thereof, is leaf. A further preferred part of a plant that is coated with a composition according to the invention, or with a dilution thereof, is a fruit, preferably a post-harvest fruit such as, for example, a citrus fruit such as orange, mandarin and lime, a pome fruit such as apple and pear, a stone fruit such as almond, apricot, cherry, damson, nectarine, tomato, watermelon, a tropical fruit such as banana, mango, lychee and tangerine. A preferred fruit is a citrus fruit, such as orange and/or a tropical fruit such as banana.

The invention further provides a method of controlling diseases caused by phytopathogenic fungi in plants or on propagation material thereof, which method comprises contacting the plants, or propagation material thereof, with a composition according to the invention, including an aqueous diluted composition.

The present invention also provides a method of controlling pest comprising contacting (i) the pest or a locus thereof, (ii) a plant or a locus or propagation material thereof, (iii) soil, and/or (iv) an area in which pest infestation is to be prevented with a composition of the invention.

The present invention also provides a method for improving pest control comprising applying any one of the compositions described herein to a plant/or soil.

The present invention also provides a method for prolonging a controlling effect of dithiocarbamate fungicide, comprising applying any one of the compositions, described herein to a plant/or soil.

In some embodiments, the target is a plant. In some embodiments, the target is a pest. In some embodiments, the pest is a fungus.

The present invention also provides a use of a composition according to the invention for increasing bioavailability of a dithiocarbamate fungicide.

The present invention also provides a use of a composition according to the invention for increasing the biological activity of a dithiocarbamate fungicide on a pest. The term “increasing biological activity” refers to curative, knock down, preventive and/or persistence performance.

The present invention also provides a use of a composition according to the invention for increasing uptake of a dithiocarbamate fungicide by a target,

The present invention also provides a use of a composition according to the invention for increasing penetration of a dithiocarbamate fungicide into a target.

In some embodiments, the target is a plant. In some embodiments, the target is a pest. In some embodiments, the pest is a fungus.

The present invention also provides a method for increasing absorbance of a dithiocarbamate fungicide by a plant tissue, comprising applying the composition of the present invention to a plant, part of a plant and/or soil.

The present invention also provides a method for increasing biological activity of a dithiocarbamate fungicide on a pest comprising applying the composition of the present invention to a plant, part of a plant and/or soil.

The present invention also provides a method for increasing the uptake of dithiocarbamate fungicide by a plant, comprising applying the composition of the present invention to the plant, part of a plant and/or soil.

The present invention also provides a method for increasing the bioavailability of a dithiocarbamate fungicide, comprising applying the composition of the present invention to a plant, part of a plant and/or soil.

The present invention also provides a method for increasing the biological activity of a dithiocarbamate fungicide on a plant comprising applying the composition of the present invention to a plant, part of a plant and/or soil.

The present invention also provides a method of increasing uptake of a dithiocarbamate fungicide by a plant, increasing penetration of a dithiocarbamate fungicide into a plant, increasing retention of a pesticide by a plant and/or increasing bioavailability of a dithiocarbamate fungicide to a plant comprising applying the composition of the present invention to the plant, part of a plant and/or soil.

The present invention also provides a method for increasing the biological activity of a dithiocarbamate fungicide on a plant comprising applying the composition of the present invention to a plant, and/or soil.

The present invention also provides a method of increasing uptake of a dithiocarbamate fungicide by a plant, increasing penetration of a dithiocarbamate fungicide into a plant, increasing retention of a dithiocarbamate fungicide by a plant and/or increasing bioavailability of a dithiocarbamate fungicide to a plant comprising applying the composition of the present invention to the plant, part of a plant and/or soil.

The invention provides the use of a composition according to the invention for increasing the biological activity of a dithiocarbamate fungicide.

The invention provides the use of a composition according to the invention for enhancing the biological activity of a dithiocarbamate fungicide.

The invention provides the use of a composition according to the invention for increasing the fungicidal activity of a dithiocarbamate fungicide.

The invention provides the use of a composition according to the invention for enhancing the fungicidal activity of a dithiocarbamate fungicide.

The invention provides the use of a composition according to the invention for prolonging the fungicidal effect of a dithiocarbamate fungicide.

In some embodiments, dithiocarbamate fungicide is mancozeb.

The invention provides the use of a composition according to the invention for increasing the biological activity of mancozeb.

The invention provides the use of a composition according to the invention for enhancing the biological activity of mancozeb.

The invention provides the use of a composition according to the invention for increasing the fungicidal activity of mancozeb.

The invention provides the use of a composition according to the invention for enhancing the fungicidal activity of mancozeb.

The invention provides the use of a composition according to the invention for prolonging the fungicidal effect of mancozeb.

The use of at polyelectrolyte complex for formulating an aqueous suspension concentrate comprising dithiocarbamate fungicide.

The use of polyelectrolyte complex for formulating an aqueous suspension concentrate comprising mancozeb.

The present invention also provides a method for pest control by preventive, curative and/or persistence treatment of a plant disease caused by phytopathologic fungi comprising contacting a plant, a locus thereof or propagation material thereof with an effective amount of any one of the herein disclosed composition comprising a dithiocarbamate fungicide. Said dithiocarbamate fungicide may include, but is not limited to, mancozeb, zineb, thiram, ziram, ferbam, metiram, propineb, and maneb.

The invention provides the use of a complex according to the invention for increasing uptake of a dithiocarbamate fungicide into a plant, increasing penetration of a dithiocarbamate fungicide into a plant, increasing retention of a dithiocarbamate fungicide by a plant and/or increasing the bioavailability of a dithiocarbamate fungicide to a plant.

The invention provides the use of a composition according to the invention for increasing the bioavailability of dithiocarbamate fungicides.

The invention provides the use of a composition according to the invention for increasing uptake of a dithiocarbamate fungicide, into a plant, increasing penetration of a dithiocarbamate fungicide into a plant, increasing retention of a dithiocarbamate fungicide by a plant and/or increasing the bioavailability of a dithiocarbamate fungicide to a plant.

The invention provides the use of a composition according to the invention for increasing the bioavailability of dithiocarbamate fungicides.

The described (compositions) may be applied to healthy or diseased plants. The described (compositions) can be used on various plants including but not limited to crops, seeds, bulbs, propagation material, or ornamental species.

The present invention provides a method of controlling a disease caused by phytopathogenic fungi on plants or propagation material thereof, comprising contacting the plants, the locus thereof or propagation material thereof with at least one of the herein defined compositions.

The present invention provides use of any one of the compositions described herein for the protection of a plant, or a part of a plant, against a pathogen.

In some embodiments, the composition is sprayed over a plant or a part of a plant.

In some embodiments, the plant part is seed or fruit.

The present invention provides a method of treating a plant, or a part of a plant, against a pathogen, comprising contacting the plant, or part of the plant, with any one of the compositions described herein.

The present invention also provides a method of protecting a plant, or a part of a plant, against a pathogen, comprising contacting said plant, or part of said plant, with any one or any combination of the compositions described herein.

The present invention also provides a method of preventing, reducing and/or eliminating the presence of a pathogen on a plant, or a part of a plant, comprising contacting said plant, or part of said plant, with any one of the compositions described herein.

In some embodiments, the plant part is leaf.

The present invention also provides a method of controlling diseases caused by phytopathogenic fungi in plants or on propagation material thereof which comprises contacting the plants, or propagation material thereof, with any one or any combination the compositions described herein.

In some embodiments, the fungus is one of Leaf Blotch of Wheat (Mycosphaerella graminicola; anamorph: Septoria tritici), Wheat Brown Rust (Puccinia triticina), Stripe Rust (Puccinia striiformis f. sp. tritici), Scab of Apple (Venturia inaequalis), Blister Smut of Maize (Ustilago maydis), Powdery Mildew of Grapevine (Uncinula necator), Barley scald (Rhynchosporium secalis), Blast of Rice (Magnaporthe grisea), Rust of Soybean (Phakopsora pachyrhizi), Glume Blotch of Wheat (Leptosphaeria nodorum), Powdery Mildew of Wheat (Blumeria graminis f. sp. tritici), Powdery Mildew of Barley (Blumeria graminis f. sp. hordei), Powdery Mildew of Cucurbits (Erysiphe cichoracearum), Anthracnose of Cucurbits (Glomerella lagenarium), Leaf Spot of Beet (Cercospora beticola), Early Blight of Tomato (Alternaria solani), and Net Blotch of Barley (Pyrenophora teres).

In some embodiments, the combination or composition of the present invention comprises a dithiocarbamate fungicide and at least one insecticide. When the composition comprises at least one insecticide, the present invention also provides a method for controlling unwanted insects comprising applying to an area infested with any one or any combination the compositions described herein.

Insects may include but are not limited to sucking insects and chewing insects.

Sucking insects may include but are not limited to aphids and stink bugs, chewing insects may include, but are not limited to, lepidoptera, helicoverpa, pollen beetle and other chewing insects such as diamondback moth.

In some embodiments, the insect is one of Isopoda (Oniscus asellus, Armadillidium vulgare, Porcello scaber), Diplopoda (Blaniulus guttulatus), Chilopoda (Geophilus carpophagus, Scutigera spp), Symphyla (Scutigerella immaculata), Thysanura (Lepisma saccharina), Collembola (Onychiurus armatus), Orthoptera (Acheta domesticus, Gryllotalpa spp., Locusta migratoria migratorioides, Melanoplus spp., Schistocerca gregaria), Blattaria (Blatta orientalis, Periplaneta americana, Leucophaea maderae, Blattella germanica), Dermaptera (Forficula auricularia), Isoptera (Reticulitermes spp), Phthiraptera (Pediculus humanus corporis, Haematopinus spp., Linognathus spp., Trichodectes spp., Damalinia spp), Thysanoptera (Hercinothrips femoralis, Thrips tabaci, Thrips palmi, Frankliniella occidentalis), Heteroptera (Eurygaster spp., Dysdercus intermedius, Piesma quadrata, Cimex lectularius, Rhodnius prolixus, Triatoma spp.), Homoptera (Aleurodes brassicae, Bemisia tabaci, Trialeurodes vaporariorum, Aphis gossypii, Brevicoryne brassicae, Cryptomyzus ribis, Aphis fabae, Aphis pomi, Eriosoma lanigerum, Hyalopterus arundinis, Phylloxera vastatrix, Pemphigus spp., Macrosiphum avenae, Myzus spp., Phorodon humui, Rhopalosiphum padi, Empoasca spp., Euscelis bilobatus, Nephotettix cincticeps, Lecanium comi, Saissetia oleae, Laodelphax striatellus, Nilaparvata lugens, Aonidiella aurantii, Aspidiotus hederae, Pseudococcus spp., Psylla spp), Lepidoptera (Pectinophora gossypiella, Bupalus piniarius, Chematobia brumata, Lithocolletis blancardella, Hyponomeuta padella, Plutella xylostella, Malacosoma neustria, Euproctis chrysorrhoea, Lymantria spp., Bucculatrix thurberiella, Phyllocnistis citrella, Agrotis spp., Euxoa spp., Feltia spp., Earias insulana, Heliothis spp., Mamestra brassicae, Panolis flammea, Spodoptera spp., Trichoplusia ni, Carpocapsa pomonella, Pieris spp., Chilo spp., Pyrausta nubilalis, Ephestia kuehniella, Galleria mellonella, Tineola bisselliella, Tinea pellionella, Hofmannophila pseudospretella, Cacoecia podana, Capua reticulana, Choristoneura fumiferana, Clysia ambiguella, Homona magnanima, Tortrix viridana, Cnaphalocerus spp., and Oulema oryzae),

From the order of the Coleoptera, for example, Anobium punctatum, Rhizopertha dominica, Bruchidius obtectus, Acanthoscelides obtectus, Hylotrupes bajulus, Agelastica alni, Leptinotarsa decemlineata, Phaedon cochleariae, Diabrotica spp., Psylliodes chrysocephala, Epilachna varivestis, Atomaria spp., Oryzaephilus surinamensis, Anthonomus spp., Sitophilus spp., Otiorrhynchus sulcatus, Cosmopolites sordidus, Ceuthorrhynchus assimilis, Hypera postica, Dermestes spp., Trogoderma spp., Anthrenus spp., Attagenus spp., Lyctus spp., Meligethes aeneus, Ptinus spp., Niptus hololeucus, Gibbium psylloides, Tribolium spp., Tenebrio molitor, Agriotes spp., Conoderus spp., Melolontha spp., Amphimallon solstitialis, Costelytra zealandica, Lissorhoptrus oryzophilus), Hymenoptera (Diprion spp., Hoplocampa spp., Lasius spp., Monomorium pharaonis, Vespa spp), Diptera (Aedes spp., Anopheles spp., Culex spp., Drosophila melanogaster, Musca spp., Fannia spp., Calliphora erythrocephala, Lucilia spp., Chrysomyia spp., Cuterebra spp., Gastrophilus spp., Hyppobosca spp., Stomoxys spp., Oestrus spp., Hypoderma spp., Tabanus spp., Tannia spp., Bibio hortulanus, Oscinella frit, Phorbia spp., Pegomyia hyoscyami, Ceratitis capitata, Dacus oleae, Tipula paludosa, Hylemyia spp., Liriomyza spp), Siphonaptera (Xenopsylla cheopis, Ceratophyllus spp), Arachnida (Scorpio maurus, Latrodectus mactans, Acarus siro, Argas spp., Ornithodoros spp., Dermanyssus gallinae, Eriophyes ribis, Phyllocoptruta oleivora, Boophilus spp., Rhipicephalus spp., Amblyomma spp., Hyalomma spp., Ixodes spp., Psoroptes spp., Chorioptes spp., Sarcoptes spp., Tarsonemus spp., Bryobiapraetiosa, Panonychus spp., Tetranychus spp., Hemitarsonemus spp., Brevipalpus spp), plant-parasitic nematodes (Pratylenchus spp., Radopholus similis, Ditylenchus dipsaci, Tylenchulus semipenetrans, Heterodera spp., Globodera spp., Meloidogyne spp., Aphelenchoides spp., Longidorus spp., Xiphinema spp., Trichodorus spp., and Bursaphelenchus spp).

In some embodiments, the combination or composition of the present invention comprises a dithiocarbamate fungicide and at least one herbicide. When the composition comprises at least one herbicide, the present invention also provides a method for controlling weed comprising applying to an area where weed is to be controlled or prevented with any one or any combination the compositions described herein, In some embodiments, the weed is one of Alopecurus myosuroides (ALOMY), Lolium perenne (LOLPE), Matricaria recutita (MATCH), Papaver rhoeas (PAPRH), and Veronica persica (VERPE).

In some embodiments, the pesticide is applied at a rate effective for controlling a pest. In some embodiments, the pesticide is applied at a rate effective for preventing infestation of the pest. In some embodiments, the pesticide is applied at a rate effective for curing infestation of the pest.

In some embodiments, a method of the invention is effective for preventing infestation of a pest. In some embodiments, the method is effective for curing infestation of the pest. In some embodiments, the method is effective for increasing the pesticidal activity of the pesticide, wherein the pesticide is which is dithiocarbamate fungicide. In some embodiments, the method is effective for prolonging the pesticidal effect of the pesticide, wherein the pesticide is which is dithiocarbamate fungicide. In some embodiments, the method is effective for increasing uptake of the pesticide by the plant, increasing penetration of the pesticide into the plant, increasing retention of the pesticide by the plant, and/or increasing the bioavailability of the pesticide to the plant, wherein the pesticide is which is dithiocarbamate fungicide.

In some embodiments, a method of the invention is effective for decreasing the half maximal effective concentration (EC50) of the dithiocarbamate fungicide. In some embodiments, the method is effective for decreasing the EC50 by at least 10%. In some embodiments, the method is effective for decreasing the EC50 by at least 25%. In some embodiments, the method is effective for decreasing the EC50 by at least 35%. In some embodiments, the method is effective for decreasing the EC50 by at least 50%.

In some embodiments, a method of the invention is effective for decreasing the LC50 of the dithiocarbamate fungicide. In some embodiments, the method is effective for decreasing the LC50 by at least 10%. In some embodiments, the method is effective for decreasing the LC50 by at least 25%. In some embodiments, the method is effective for decreasing the LC50 by at least 50%. In some embodiments, the method is effective for decreasing the LC50 by at least 75%. In some embodiments, the method is effective for decreasing the LC50 by at least 90%.

In some embodiments, a method of the invention is effective for decreasing the LC90 of the dithiocarbamate fungicide. In some embodiments, the method is effective for decreasing the LC90 by at least 10%. In some embodiments, the method is effective for decreasing the LC90 by at least 25%. In some embodiments, the method is effective for decreasing the LC90 by at least 50%. In some embodiments, the method is effective for decreasing the LC90 by at least 75%. In some embodiments, the method is effective for decreasing the LC90 by at least 90%.

In some embodiments, a method of the invention further comprises applying at least one additional agrochemical to a pest, a plant part, a plant, the locus, or propagation material thereof.

In some embodiments, the composition is tank mixed with an additional agrochemical. In some embodiments, the composition is applied sequentially with the additional agrochemical.

In some embodiments, the composition is tank mixed with an additional adjuvant. In some embodiments, the composition is applied sequentially with an additional adjuvant.

In some embodiments, the adjuvant is selected from group consisting of plant oil derivatives. In some embodiments, the plant oil derivative is a vegetable oil derivative. In some embodiments, the vegetable oil derivative is a soybean oil methyl ester.

Each embodiment disclosed herein is contemplated as being applicable to each of the other disclosed embodiments. Thus, all combinations of the various elements described herein are within the scope of the invention. In addition, the elements recited in composition embodiments can be used in the composition, method, use, process, delivery system embodiments described herein and vice versa.

The invention is illustrated by the following examples without limiting it thereby.

### 4. EXPERIMENTAL SECTION

Several compositions with varying polyelectrolyte complex and mancozeb were tested in the experiments described herein below:

Polyelectrolyte complex of chitosan, polyallylamine (PAA) or poly-L-lysine (PLL) as polycations, in combination with lignosulfonate as polyanion.

Materials and Methods

The compositions are as follows:
DT-CE-M2-300-01T: a composition comprising mancozeb and lignosulfonate-chitosan polyelectrolyte complex
DT-CE-M2-300-02T: a composition comprising mancozeb and lignosulfonate-PAA polyelectrolyte complex

The following is a lab scale procedure for the preparation of invention composition:
1) Dissolve Polycation (Chitosan or Poly-allyamine) in water and 1,2 propanediol while stirring in acidic conditions, using, for example 0.4% w/v of acetic acid.
2) Add polyanion (Borresperse CA) into the polycation solution and mix for an additional 15-30 minutes.
3) Add the mancozeb portion-wise and mix for an additional 15-30 minutes.
4) Add antifoaming, Silcolapse 426R.
5) Add Metasperse 500L and Atlas G5002L and mix for 15-30 minutes.
6) Milling for 5 min with dispermat.
7) Add the 2% in water Rhodopol 23 pregel and the biocide (Acticide MBS) to the post milled suspension and mix until a homogeneous formulation is obtained, 30-60 minutes

Note:
All the addition and mixing time were performed using a mechanical stirrer.
The milling was performed using a Dispermat SL Nano with a 50 mL milling chamber full for ≈80% of ZrO₂ beads 0.75-1.0 mm in size.

Typical in-process parameters are summarized in Table 1 below.

TABLE 1
Typical in-process parameters

| | | | Viscosity |
|---|---|---|---|
| | Particles size | | mPas |
| Steps | d₅₀ | d₉₀ | (Brookfield SP-63) |
| End of step 2 - PEM suspension | 7 | 67 | 50 |
| End of step 3 - After addition of AI | 1.2 | 2.5 | 500 |
| End of step 5 - After addition of | 1.6 | 3.8 | 50 |
| surfactants | | | |
| End of step 6 - After milling | 1.1 | 2.6 | 150 |
| End of step 7 - After Xanthan gum | 1.1 | 2.6 | 300 |
| dispersion | | | |

### Example 1. Composition of Mancozeb and Lignosulfonate-Chitosan Polyelectrolyte Complex

A composition of mancozeb and lignosulfonate-chitosan polyelectrolyte complex (DT-CE-M2-300-01T, shown in Table 2) was prepared and its physicochemical properties are summarized in Tables 3.

### Preparation Method for DT-CE-M2-300-01T

1) Dissolution of chitosan in water and 1,2 propanediol cosolvent while stirring in acidic conditions using, for example, 0.4% w/v of acetic acid.
2) Add lignosulfonate into the chitosan solution and mix for an additional 15-30 minutes.
3) Addition of mancozeb portion-wise and mixing for an additional 15-30 minutes period.
4) Addition of antifoaming, Rhodorsil 426R.
5) Addition of dispersant Metasperse 500L and Atlas G5002L and mixing for 15-30 minutes.
6) Milling for 5 min with Dispermat SL Nano milling machine in a 50 ml milling chamber with ZrO2 beads of 0.75-1.0 mm in size.
7) Addition of 2% in water Rhodopol 23 pregel and the biocide (Acticide MBS) to the post milled suspension and mixing until a homogeneous formulation is obtained, 30-60 minutes.

TABLE 2
Composition comprising mancozeb and lignosulfonate-
chitosan polyelectrolyte complex (DT-CE-M2-300-01T)

| Ingredients | g/L | % w/w |
|---|---|---|
| Distilled Water | 642.4 | 53.2% |
| Mancozeb 91% | 360.0 | 30.1% |
| Chitosan (WSC-2 GTC) | 5.6 | 0.5% |
| CaLS (Borresperse-Ca) | 28.0 | 2.3% |
| Metasphere 500L | 24.0 | 2.1% |
| Atlas G5002L | 24.0 | 2.1% |
| Rhodorsil 426R | 5.0 | 0.5% |
| propan 1,2 diol | 50.0 | 4.1% |
| acticide MBS | 1.000 | 0.084% |
| Rhodopol 23 | 60.0 | 5.2% |
| Total | 1200.0 | 100.00% |

TABLE 3
Physicochemical properties of DT-CE-M2-300-01T

| Viscosity (cP) | | Particle size (pm) | | | |
|---|---|---|---|---|---|
| S63 R12 rpm | S63 R60 rpm | d0.5 | d0.9 | pH | density (g/mL) |
| 915 | 392 | 1.7 | 9.3 | 6.35 | 1.214 |

### Example 2. Composition of Mancozeb and Lignosulfonate-PAA Polyelectrolyte Complex

A composition of mancozeb and lignosulfonate-PAA polyelectrolyte complex (DT-CE-M2-300-02T, shown in Table 4) was prepared and its physicochemical properties are summarized in Table 5.

### Preparation Method for DT-CE-M2-300-02T

1) Dilution of PAA Hydrochloride in water and 1,2 propanediol cosolvent while stirring.
2) Add lignosulfonate into the chitosan solution and mix for an additional 15-30 minutes.
3) Addition of mancozeb portion-wise and mixing for an additional 15-30 minutes period.
4) Addition of antifoaming, Rhodorsil 426R.
5) Addition of dispersant Metasperse 500L and Atlas G5002L and mixing for 15-30 minutes.
6) Milling for 5 min with Dispermat SL Nano milling machine in a 50 ml milling chamber with ZrO2 beads of 0.75-1.0 mm in size.
7) Addition of 2% in water Rhodopol 23 pregel and the biocide (Acticide MBS) to the post milled suspension and mixing until a homogeneous formulation is obtained, 30-60 minutes.

TABLE 4
Composition comprising mancozeb and lignosulfonate-
PAA polyelectrolyte complex (DT-CE-M2-300-02T)

| Ingredients | g/L | % w/w |
|---|---|---|
| Distilled Water | 636.9 | 53.1% |
| Mancozeb 91% | 360.0 | 29.9% |
| PAA 50% | 11.2 | 1.0% |
| CaLS (Borresperse-Ca) | 27.9 | 2.3% |
| Atlas G5002L | 24.0 | 2.1% |
| metasperse 500L | 24.0 | 2.1% |
| Rhodorsil 426R | 5.0 | 0.5% |
| propan 1,2 diol | 50.0 | 4.1% |
| acticide MBS | 1.000 | 0.081% |
| Rhodopol 23 | 60.0 | 5.0% |
| Total | 1200.0 | 100.00% |

TABLE 5
Physicochemical properties of DT-CE-M2-300-02T

| Viscosity (cP) | | Particle size (pm) | | | |
|---|---|---|---|---|---|
| S63 R12 rpm | S63 R60 rpm | d0.5 | d0.9 | pH | density (DMA) |
| 1070 | 344 | 1.7 | 9.9 | 6.34 | 1.216 |

TABLE 6
CF1700-21 = DT-CE-M2-300-02T

| Ingredient | g/L | % w/w | Function | Physical state |
|---|---|---|---|---|
| Distilled Water | 577.8 | 48.2% | Continues phase | Liquid |
| Propan 1,2 diol | 50.0 | 4.2% | Antifreeze-cosolvent | Low viscosity liquid |
| Poly-allylamine HCl (50% in water) | 11.2 | 0.9% | Polycation | Medium viscosity liquid |
| Borresperse CA | 28.0 | 2.3% | Polyanion | Powder |
| Mancozeb 86% (360 g/L PURE) | 419.0 | 34.9% | AI | Powder |
| Silcolapse 426R | 5.0 | 0.4% | Antifoaming | Low viscosity liquid |
| Metasperse 500L | 24.0 | 2.0% | Dispersing agent | Medium viscosity liquid |
| Atlas G5002L | 24.0 | 2.0% | Wetting agent | High visoctiy liquid |
| Acticide MBS | 1.000 | 0.08% | Biocide | Liquid |
| Rhodopol 23 (2% gel in water) | 60.0 | 5.0% | Rheology modifier | Gel |
| Total | 1200.0 | 100.00% | | |

In compositions formulated with Metasperse 500+Atlas G5002L, there were no phase separation and/or agglomeration after 1 week at room temperature.

### Example 3. Composition of Mancozeb and Lignosulfonate-PAA Polyelectrolyte Complex

The composition described below is made with an increased amount of mancozeb to provide a minimum mancozeb concentration of 350 g/L. The mancozeb loading was adjusted to meet a concentration of 360 g/L using the last available batch that has a purity of 920%.

TABLE 7
Composition of mancozeb and lignosulfonate-
PAA polyelectrolyte complex (CF1700-21-08)

| Ingredient | g/L | % w/w |
|---|---|---|
| Distilled Water | 605.8 | 50.5% |
| Mancozeb 92% | 391.0 | 32.6% |
| PAA 50% | 11.2 | 0.9% |
| CaLS (Borresperse CA) | 28.0 | 2.3% |
| Atlas G5002L | 24.0 | 2.0% |
| Metasperse 500L | 24.0 | 2.0% |
| Silcolapse 426R | 5.0 | 0.4% |
| Propan 1,2 diol | 50.0 | 4.2% |
| Acticide MBS | 1.000 | 0.08% |
| Rhodopol 23 (2% gel in water) | 60.0 | 5.0% |
| Total | 1200.0 | 100.00% |

TABLE 8
Physicochemical properties of CF1700 (CF1700-21-08)

| | |
|---|---|
| pH | 6.26 |
| density (g/mL) | 1.222 |
| Viscosity (SP63 - 12 rpm - mPas) | 1500 |
| Viscosity (SP63 - 60 rpm - mPas) | 460 |
| Particle size (d₅₀ - pm) | 1.0 |
| Particle size (d₉₀ - pm) | 1.7 |

### Example 4. Composition of Mancozeb and Lignosulfonate-PAA Polyelectrolyte Complex

A composition of mancozeb and lignosulfonate-PAA polyelectrolyte complex was prepared.

The composition of mancozeb and lignosulfonate-PAA complex was produced with 3% instead of 2% of both dispersant and wetting agent, and with 4% instead of 5% of xanthan gum pre-gel to improve the viscosity increase issue observed in the previous prototypes.

The composition of mancozeb and lignosulfonate-PAA polyelectrolyte complex of the present invention (CF 1705) is provided in Table 9. The physicochemical properties of CF1705 is summarized in Table 10.

TABLE 9
Composition of mancozeb and lignosulfonate-
PAA polyelectrolyte complex (CF1705)

| Ingredient | g/L | w/w % | Function |
|---|---|---|---|
| Distilled Water | 566.8 | 47.2% | Continuous phase |
| Mancozeb 86.1% (Batch | 418.0 | 34.8% | AI |
| 242288) | | | |
| PAA 50% | 11.2 | 0.9% | Polycation |
| CaLS (Borresperse-Ca) | 28.0 | 2.3% | Polyanion |
| Atlas G5002L | 36.0 | 3.0% | Wetting agent |
| Metasperse 500L | 36.0 | 3.0% | Dispersant |
| Silcolapse 426R | 5.0 | 0.4% | Antifoaming |
| propan 1,2 diol | 50.0 | 4.2% | Antifreeze- |
| | | | cosolvent |
| acticide MBS | 1.000 | 0.08% | Biocide |
| Rhodopol 23 (2% gel | 48.0 | 4.0% | Rheology modifier |
| in water) | | | |
| Total | 1200.0 | 100.00% | |

TABLE 10
Physicochemical properties of CF1705

| Batches | 26-01 | 26-02 | 26-03 |
|---|---|---|---|
| pH pure | 6.6 | 6.6 | 6.6 |
| Density (g/mL) | 1.23 | 1.24 | 1.24 |
| Viscosity (SP63 - 12 rpm) | 610 | 840 | 880 |
| Viscosity (SP63 - 60 rpm) | 260 | 350 | 360 |
| DIN 4 CUP (s) | 24 | 27 | 29 |
| Particle size d₅₀ (μm) | 1.1 | 1.1 | 1.1 |
| Particle size d₉₀ (μm) | 2.9 | 2.7 | 2.6 |

Comparative Data

Four composition with other dispersants were tested, and the results are summarized in Tables 11a-d.

TABLE 11a

| | g/L | % w/w |
|---|---|---|
| Distilled Water | 528.6 | 44.0% |
| Mancozeb (85% w/w - Mz | 450 | 37.5% |
| pure 382 g/L - 31.8% w/w) | | |
| Chitosan | 5.6 | 0.45% |
| HCl 36% | 2.8 | 0.23% |
| Borresperse CA | 28 | 2.3% |
| Soprophor FL | 30 | 2.5% |
| Atlox 4913 | 40 | 3.3% |
| Rhpdprsil 426R | 5 | 0.4% |
| propan 1,2 diol | 50 | 4.2% |
| Rhodoppl 23 pregel | 60 | 5.0% |
| Total | 1200 | 100% |

TABLE 11b

| | g/L | % w/w |
|---|---|---|
| Distilled Water | 528.6 | 44.0% |
| Mancozeb (85% w/w - Mz | 450 | 37.5% |
| pure 382 g/L - 31.8% w/w) | | |
| Chitosan | 5.6 | 0.45% |
| HCl 36% | 2.8 | 0.23% |
| Borresperse CA | 28 | 2.3% |
| Soprophor FL | 30 | 2.5% |
| Atlas G5002L | 40 | 3.3% |
| Rhpdprsil 426R | 5 | 0.4% |
| prppan 1,2 diol | 50 | 4.2% |
| Rhodoppl 23 pregel | 60 | 5.0% |
| Total | 1200 | 100% |

TABLE 11c

| | g/L | % w/w |
|---|---|---|
| Distilled Water | 520.6 | 43.4% |
| Mancozeb (85% w/w - Mz | 480 | 40.0% |
| pure 408 g/L - 34% w/w) | | |
| Chitosan | 5.6 | 0.45% |
| HCl 36% | 2.8 | 0.23% |
| Borresperse CA | 28 | 2.3% |
| Atlox ™ PN-100 | 48 | 4.0% |
| Rhodorsil 426R | 5 | 0.4% |
| propan 1,2 diol | 50 | 4.2% |
| Rhodoppl 23 | 60 | 5.0% |
| Total | 1200 | 100% |

TABLE 11d

| | g/L | % w/w |
|---|---|---|
| Distilled Water | 544.6 | 45.4% |
| Mancozeb (85% w/w - Mz | 480 | 40.0% |
| pure 408 g/L - 34% w/w) | | |
| Chitosan | 5.6 | 0.45% |
| HCl 36% | 2.8 | 0.23% |
| Borresperse CA | 28 | 2.3% |
| Atlox ™ PN-100 | 24 | 2.0% |
| Rhodorsil 426R | 5 | 0.4% |
| propan 1,2 diol | 50 | 4.2% |
| Rhodoppl 23 | 60 | 5.0% |
| Total | 1200 | 100% |

General Procedure
1. Dissolve Chitosan in water and 1,2 propanediol while stirring. In acidic conditions using 0.4% w/v of acetic acid
2. Add Calcium lignosulfonate into the chitosan solution and mix for an additional 15-30 minutes.
3. Add the Mancozeb portion-wise and mix for an additional 15-30 minutes.
4. Add antifoaming, Silcolapse 426R.
5. Add dispersant and wetting agent (in the sequence as written in Table 12) and mix for 15-30 minutes.
6. Milling for 5 min with dispermat.
7. Add the 2% in water Rhodopol 23 pre-gel and the biocide (Acticide MBS) to the post milled suspension and mix until a homogeneous formulation is obtained, 30-60 minutes.

Physicochemical properties such as viscosity, aggregation, and phase separation for the different compositions were measured and summarized in Table 12.

TABLE 12
Comparative data of compositions with different dispersants

| | Viscosity | Aggregation | |
|---|---|---|---|
| | (SP63 - | after 1 | Phase separation |
| | 60 rpm) | week at room | (More than 10% |
| Surfactants | T zero | temperature | 1 week at RT) |
| Soprophor FL 2.5% + | >2000 | yes | yes |
| Atlox4913 3.3% | | | |
| Soprohor FL 2.5% + | >2000 | yes | yes |
| Atlas G5002L 3.3% | | | |
| Atlox TM PN-100 4.0% | 1610 | yes | yes |
| Atlox TM PN-100 2.0% | 1078 | yes | yes |

1. An aqueous concentrate composition comprising a polyelectrolyte complex, a dithiocarbamate fungicide, an aqueous carrier, and an agriculturally acceptable additive.

2. The aqueous composition of claim 1, wherein:
a) the polyelectrolyte complex is an insoluble solid in the aqueous carrier,
b) the concentration of the polyelectrolyte complex in the composition is between 1 and 50 g/kg,
c) the polyelectrolyte complex is a complex of at least one polycation and at least one polyanion,
d) the concentration of the dithiocarbamate fungicide in the composition is between 350 and 450 g/L,
e) the concentration of the dithiocarbamate fungicide in the composition is 30-40% by weight or 28-37% by weight based on the total weight of the composition, and/or
f) the agriculturally acceptable additive is a dispersant.

3. (canceled)

4. (canceled)

5. The aqueous composition of claim 1, wherein the polyelectrolyte complex is a complex of at least one polycation and at least one polyanion, and wherein:
a) the polycation is selected from the group consisting of cationic starch, poly(allylamine) (PAA), chitosan, epsilon-poly (L-lysine), chitosan derivatives such as thiolated chitosan, 5-methyl-pyrrolidinone-chitosan and chitosan oligosaccharide, DEAE-dextran and any combination thereof,
b) the polyanion is selected from the group consisting of alginate, a lignin compound, pectin, carrageenan, humic acid, fulvic acid, sodium alkyl naphtalene sulfonate, poly-γ-glutamic acid, maleic starch half-ester, carboxymethyl cellulose, chondroitin sulphate, dextran sulphate, hyaluronic acid, poly(acrylic acid), polyphosphoric acid, poly(L-lactide) and any combination thereof,
c) the concentration of the polycation in the composition is 0.01-10% by weight based on the total weight of the composition, and/or
d) the concentration of the polyanion in the composition is 0.01-10% by weight based on the total weight of the composition.

6. The aqueous composition of claim 1, wherein the polyelectrolyte complex is a complex of at least one polycation and at least one polyanion, and wherein:
a) the polycation is poly(allylamine) (PAA), chitosan, epsilon-poly (L-lysine) or any combination thereof, and/or
b) the polyanion is lignosulfonate.

7. (canceled)

8. (canceled)

9. (canceled)

10. (canceled)

11. (canceled)

12. (canceled)

13. (canceled)

14. (canceled)

15. (canceled)

16. The aqueous composition of claim 1, wherein the composition comprises a dispersant and wherein:
a) the dispersant is anionic,
b) the dispersant is selected from the group consisting of lignosulfonate, modified acrylic polymer or any combination thereof, and/or
c) the concentration of the dispersant in the composition is 1-12% by weight based on the total weight of the composition.

17. (canceled)

18. The aqueous composition of claim 16, wherein the modified acrylic polymer is modified styrene acrylic polymer, polymethyl methacrylate-polyethylene glycol graft copolymer or any combination thereof.

19. (canceled)

20. (canceled)

21. The aqueous composition of claim 1, wherein the composition comprises a wetting agent, an anti-foam agent, an antifreezing agent, a non-ionic hydrocarbon-based surfactant that is not tristyrylphenyl ether phosphate, a preservative, a rheology modifier, and/or an additional bioactive ingredient.

22. The aqueous composition of claim 21, wherein:
a) the wetting agent is nonionic and/or a polyalkylene oxide block copolymer,
b) the anti-foam forming agent is silicone-based,
c) the antifreezing agent is propylene glycol, and/or
d) the preservative is a biocide.

23. (canceled)

24. The aqueous composition of claim 21, wherein:
a) the concentration of the wetting agent in the composition is 1-10% by weight based on the total weight of the composition,
b) the concentration of the anti-foam forming agent is 0.1-1% by weight based on the total weight of the composition,
c) the concentration of the antifreezing agent in the composition is 1-10% by weight based on the total weight of the composition,
d) the concentration of the non-ionic hydrocarbon-based surfactant in the composition is 0.001-0.1% by weight based on the total weight of the composition,
e) the concentration of the preservative in the composition is 0.01-5% by weight based on the total weight of the composition, and/or
f) the concentration of the rheology modifier in the composition is 1-10% by weight based on the total weight of the composition.

25. (canceled)

26. The aqueous composition of claim 1, wherein the composition comprises a dispersant and a wetting agent, and wherein:
a. the dispersant is anionic and the wetting agent is non-ionic,
b) the dispersant is a modified styrene acrylic polymer and the wetting agent is a polyalkylene oxide block copolymer, and/or
c. the weight ratio between the dispersant and the wetting agent in the composition is between 2:1 to 1:2.

27-42. (canceled)

43. The aqueous composition of claim 1, wherein the composition comprises:
a. 28-37% w/w of mancozeb,
b. 0.3-0.1.2% w/w of polycation,
c. 2-2.5% w/w of polyanion,
d. 4-4.5% w/w of anti-freeze agent,
e. 0.2-0.7% w/w of silicone-based anti-foam agent,
f. 1.5-3.5% w/w of dispersant,
g. 1.5-3.5% w/w of wetting agent,
h. 0.05-0.1% w/w of biocide,
i. 4.5-5.5% w/w of rheology modifier, and
j. 45-55% w/w of water.

44. The aqueous composition of claim 1, wherein:
a) the composition is in the form of a suspension concentrate,
b) the composition comprises solid particles having d50 of 2 microns or less,
c) the composition comprises solid particles having d90 of 10 microns or less, and/or
d) the composition has a viscosity of 1000 mPas or less (Brockfield SP63—60 rpm).

45. (canceled)

46. (canceled)

47. (canceled)

48. A process for producing the aqueous composition of claim 1 comprising the following steps:
(a) obtaining the polyelectrolyte complex,
(b) mixing the polyelectrolyte complex obtained in step (a) with the dithiocarbamate fungicide and the agriculturally acceptable additive.

49. The process of claim 48, wherein:
a) the polyelectrolyte complex is obtained by mixing polycation with polyanion in the presence of aqueous carrier,
b) the dithiocarbamate fungicide is mancozeb, and/or
c) the agriculturally acceptable additive is a dispersant and the dispersant is lignosulfonate, modified acrylic polymer or combination hereof.

50. (canceled)

51. (canceled)

52. (canceled)

53. (canceled)

54. (canceled)

55. The process of claim 48, wherein the composition comprises a stabilizer, anti-foam forming agent, antifreezing agent, surfactant, wetting agent, biocide and/or rheology modifier, and step (b) comprises mixing the stabilizer, anti-foam forming agent, antifreezing agent, surfactant, wetting agent, biocide and/or rheology modifier with the composition obtained in step (a) and (b) and the agriculturally acceptable carrier.

56. (canceled)

57. A delivery system comprising a polyelectrolyte complex, a dithiocarbamate fungicide, an aqueous carrier and an agriculturally acceptable additive.

58. A method of treating a plant, or a part of a plant, against a pathogen, comprising contacting the plant, or part of the plant, with the aqueous composition of claim 1.

59. The method of claim 58, wherein the aqueous composition is applied at an amount of 0.01-2 g/ha of the dithiocarbamate fungicide and/or the dithiocarbamate fungicide is mancozeb.

60. (canceled)

61. The method of claim 58, wherein treating the plant, or a part of the plant, against a pathogen comprises:
a) protecting a plant, or a part of a plant, against a pathogen, comprising contacting said plant, or part of said plant, with the aqueous composition of claim 1,
b) preventing, reducing and/or eliminating the presence of a pathogen on a plant, or a part of a plant, comprising contacting said plant, or part of said plant, with the aqueous composition of claim 1, or
c) controlling diseases caused by phytopathogenic fungi in plants or on propagation material thereof which comprises contacting the plants, or propagation material thereof, with the aqueous composition of claim 1.

62. (canceled)

63. (canceled)

64. (canceled)

65. A method for (i) increasing biological activity of a dithiocarbamate fungicide on a target, (ii) increasing uptake of a dithiocarbamate fungicide into a target, (iii) increasing penetration of a dithiocarbamate fungicide into a target, (iv) increasing retention of a dithiocarbamate fungicide by a target, (v) increasing absorbance of a dithiocarbamate fungicide by a target, and/or (vi) increasing or enhancing bioavailability of a dithiocarbamate fungicide to a target comprising applying the composition of claim 1 to the plant, part of a plant and/or soil.
